(19) United States
(12) Patent Application Publication
(10) Pub. No.: US 2023/0214287 A1
(43) Pub. Date: Jul. 6, 2023

(54) SYSTEM, METHOD, AND COMPUTER PROGRAM PRODUCT FOR LOCATION AWARE DEVICE FAULT DETECTION

(71) Applicant: Assurant, Inc., New York, NY (US)

(72) Inventors: Mircea IONESCU, Wooster, OH (US); Patrick Scott MCLAUGHLIN, Westlake, OH (US)

(21) Appl. No.: 18/147,268

(22) Filed: Dec. 28, 2022

Related U.S. Application Data
(60) Provisional application No. 63/266,225, filed on Dec. 30, 2021.

(51) Int. Cl. G06F 11/07; G06N 20/00

(52) U.S. Cl. CPC G06F 11/0769; G06F 11/0721; G06N 20/00

(57) ABSTRACT

A system, method, and computer program product for identifying location-specific faults are provided. Some embodiments may include receiving first device status data associated with a first computing device and the first device status data may comprise first location-indicative data indicative of a location. Some embodiments may include comparing the first device status data with second device status data associated with one or more second computing devices and the second device status data may comprise second location-indicative data indicative of the location. In some embodiments, based on the comparison of the first device status data and the second device status data, determining that the first computing device is affected by one or more of a device-specific fault or a location-specific fault. Some embodiments may include causing information regarding the device-specific fault or the location-specific fault to be displayed via a graphical user interface.

### CROSS REFERENCE TO RELATED APPLICATIONS

This application claims priority to Provisional Application No. 63/266,225, filed Dec. 30, 2021, the content of which is incorporated herein by reference in its entirety.

### TECHNICAL FIELD

Embodiments of the present disclosure relate generally to computer technology and, more particularly, relate to a system, method, apparatus, and computer program product for providing computing device support services, including for location aware device fault detection. Some embodiments of the present disclosure relate to identifying and differentiating between location-specific faults and device-specific faults associated with computing devices.

### BACKGROUND

Applicant has identified a number of deficiencies and problems associated with present systems, methods, and computer program products for computing device fault detection. Through applied effort, ingenuity, and innovation, many of these identified problems have been solved by developing solutions that are included in embodiments of the present disclosure, many examples of which are described in detail herein.

### BRIEF SUMMARY

In an embodiment, a method is provided. In some embodiments, the method includes receiving first device status data associated with a first computing device. In some embodiments, the first device status data comprises first location-indicative data indicative of a location. In some embodiments, the method includes comparing the first device status data with second device status data associated with one or more second computing devices. In some embodiments, the second device status data comprises second location-indicative data indicative of the location. In some embodiments, based on the comparison of the first device status data and the second device status data, the method includes determining that the first computing device is affected by one or more of a device-specific fault or a location-specific fault. In some embodiments, the method includes causing information regarding the one or more of the device-specific fault or the location-specific fault to be displayed via a graphical user interface.

In some embodiments, the comparison of the first device status data and the second device status data is done by a trained machine learning model executed by machine learning circuitry. In some embodiments, the trained machine learning model was trained using historical device status datasets comprising historical location-indicative datasets from a plurality of computing devices experiencing a location-specific fault. In some embodiments, in an instance in which the first computing device is affected by the location-specific fault, the method includes classifying the location-specific fault as a first type of location-specific fault using the trained machine learning model. In some embodiments, the first type of the location-specific fault may be one of a global positioning system fault, a Wi-Fi fault, or a cellular fault. In some embodiments, the first type of the location-specific fault may be one of a global positioning system network fault, a Wi-Fi network fault, or a cellular network fault.

In some embodiments, the first location-indicative data and the second location-indicative data may be based on one or more of global positioning system data, cellular data, or Wi-Fi data. In some embodiments, the first location-indicative data being indicative of the location means that the first computing device is within a recognized geographical zone and wherein the second location-indicative data being indicative of the location means that the second computing devices is within the recognized geographical zone. In some embodiments, a size of the recognized geographical zone is determined based at least in part on the one or more types of location-indicative data used to determine the first location-indicative data and the second location-indicative data.

In some embodiments, the first location-indicative data is provided in real-time.

In some embodiments, the first device status data further comprises first device performance data and the second device status data further comprises second device performance data. In some embodiments, the method includes comparing the first device status data with third device status data associated with one or more third computing devices. In some embodiments, the third device status data comprises third device performance data and third location-indicative data indicative of at least one second location. In some embodiments, the at least one second location is different than the location. In some embodiments, the first computing device is affected by the device-specific fault in an instance in which the first device performance data is substantially equivalent to the third device performance data. In some embodiments, the first computing device is affected by the location-specific fault in an instance in which the first device performance data is different than the third device performance data. In some embodiments, the first computing device is affected by the location-specific fault when the first device performance data is substantially equivalent to the second device performance data. In some embodiments, the first computing device is affected by the device-specific fault when the first device performance data is different than the second device performance data.

In some embodiments, the first device status data further comprises an indication of at least one fault.

In some embodiments, the one or more device-specific fault may be a software fault or a hardware fault.

In some embodiments, the method includes receiving, in response to displaying the information regarding the one or more of the device-specific fault or the location-specific fault at the first computing device, permission to initiate enhanced diagnostics.

In some embodiments, the first computing device and the one or more second computing devices have a device profile, the device profile comprising one or more characteristics.

In another embodiment, a system is provided. In some embodiments, the system may receive first device status data associated with a first computing device. In some embodiments, the first device status data comprises first location-indicative data indicative of a location. In some embodiments, the system may compare the first device status data with second device status data associated with one or more second computing devices. In some embodiments, the second device status data comprises second location-indicative data indicative of the location. In some embodiments, based on the comparison of the first device status data and the second device status data, the system may determine that the first computing device is affected by one or more of a device-specific fault or a location-specific fault. In some embodiments, the system may cause information regarding the one or more of the device-specific fault or the location-specific fault to be displayed via a graphical user interface.

In some embodiments, the comparison of the first device status data and the second device status data is done by a trained machine learning model executed by machine learning circuitry. In some embodiments, the trained machine learning model was trained using historical device status datasets comprising historical location-indicative datasets from a plurality of computing devices experiencing a location-specific fault.

In some embodiments, the first location-indicative data and the second location-indicative data may be based on one or more of global positioning system data, cellular data, or Wi-Fi data. In some embodiments, the first location-indicative data being indicative of the location means that the first computing device is within a recognized geographical zone. In some embodiments, the second location-indicative data being indicative of the location means that the second computing devices is within the recognized geographical zone. In some embodiments, a size of the recognized geographical zone is determined based at least in part on the one or more types of location-indicative data used to determine the first location-indicative data and the second location-indicative data.

In some embodiments, the system may classify the location-specific fault as a first type of location-specific fault using a trained machine learning model executed by machine learning circuitry. In some embodiments, the first type of location-specific fault may be one of a global positioning system fault, a Wi-Fi fault, or a cellular fault.

In some embodiments, the first location-indicative data is provided in real-time.

In some embodiments, the first device status data further comprises first device performance data and the second device status data further comprises second device performance data. In some embodiments, the system may compare the first device status data with third device status data associated with one or more third computing devices. In some embodiments, the third device status data comprises third device performance data and third location-indicative data indicative of at least one second location. In some embodiments, the at least one second location is different than the location. In some embodiments, the first computing device is affected by the device-specific fault in an instance in which the first device performance data is substantially equivalent to the third device performance data. In some embodiments, the first computing device is affected by the location-specific fault in an instance in which the first device performance data is different than the third device performance data.

In some embodiments, the first device status data further comprises an indication of at least one fault.

In some embodiments, the system may receive, in response to displaying the information regarding the one or more of the device-specific fault or the location-specific fault at the first computing device, permission to initiate enhanced diagnostics.

In yet another embodiment, a computer program product is provided. In some embodiments, the computer program product may direct a system to receive first device status data associated with a first computing device. In some embodiments, the first device status data comprises first location-indicative data indicative of a location. In some embodiments, the computer program product may direct a system to compare the first device status data with second device status data associated with one or more second computing devices. In some embodiments, the second device status data comprises second location-indicative data indicative of the location. In some embodiments, based on the comparison of the first device status data and the second device status data, the computer program product may direct a system to determine that the first computing device is affected by one or more of a device-specific fault or a location-specific fault. In some embodiments, the computer program product may direct a system to cause information regarding the one or more of the device-specific fault or the location-specific fault to be displayed via a graphical user interface.

### BRIEF DESCRIPTION OF THE DRAWINGS

Having thus described certain embodiments of the present disclosure in general terms, reference will now be made to the accompanying drawings, which are not necessarily drawn to scale, and wherein:

FIG. 1 illustrates a system for providing computing device support services, including for identifying and differentiating between location-specific faults and device-specific faults in accordance with one or more embodiments of the present disclosure;

FIG. 2 illustrates a block diagram of a computing device support apparatus in accordance with one or more embodiments of the present disclosure;

FIG. 3 illustrates a block diagram of a computing device in accordance with one or more embodiments of the present disclosure;

FIG. 4 illustrates an example location detection of computing devices in accordance with one or more embodiments of the present disclosure;

FIG. 5 illustrates another example location detection of computing devices in accordance with one or more embodiments of the present disclosure;

FIG. 6 illustrates another example location detection of computing devices in accordance with one or more embodiments of the present disclosure;

FIG. 7 illustrates an example graphical user interface of the computing device in accordance with one or more embodiments of the present disclosure;

FIG. 8 illustrates another example graphical user interface of the computing device in accordance with one or more embodiments of the present disclosure; and

FIG. 9 illustrates a flowchart according to an example method for providing computing device support services, including for identifying and differentiating between location-specific faults and device-specific faults in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

### Overview

As computing devices have continued to advance at a rapid pace, usage of computing devices has reached almost every facet of consumers lives. As part of this rapid growth, the complexity of both computing devices themselves and the infrastructure that supports the computing devices (e.g., global positioning systems, cellular systems, and Wi-Fi systems) has increased exponentially. Although the increase in complexity has equipped computing devices with capabilities far beyond what was envisioned as possible even a few years ago, it has also caused computing devices to be affected by more complex and difficult to diagnose performance issues that may be caused by the computing devices themselves (e.g., device-specific faults) or by the infrastructure that supports the computing devices (e.g. location-specific faults).

In light of the increased complexity and difficulty in diagnosing performance issues, consumers who experience a performance issue are more likely than ever to seek professional assistance from manufactures, carriers, mobile network operators, retailers, wholesalers, and other industry providers in diagnosing and remedying performance issues with their computing device. As a result, manufactures, carriers, mobile network operators, retailers, wholesalers, and other industry providers are often investing substantial financial and customer service resources into diagnosing computing device performance issues, only to find that the performance issues with a consumer's computing device are being caused by a fault associated with the infrastructure that supports the computing devices rather than a fault associated with the computing device. As such, there is a need for systems, methods, and computer program products that are capable of location aware fault detection. In some embodiments, the systems, methods, and/or computer program products may operate remotely, automatically, and/or without technical user action to determining whether a computing device performance issue is being caused by the computing device itself or the infrastructure that supports the computing devices.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” which refers to a physical storage medium (e.g., volatile or non-volatile memory device), may be differentiated from a “computer-readable transmission medium,” which refers to an electromagnetic signal.

As used herein, the terms “user”, “client”, and/or “request source” refer to an individual or entity that is a source, and/or is associated with sources, of a request for messages and/or related content to be provided by a message object control system and/or any other system capable of providing messages and/or related content to the individual and/or entity. For example, a “user” and/or “client” may be the owner and/or entity that seeks information and options associated with preparing and/or otherwise planning for one or more potential events.

As used herein, the term “device status data” may refer to any information associated with a computing device. As an example, as used herein, “device status data” may include, but is not limited to, “device performance data” and “location-indicative data.”

As used herein, the term “device performance data” may refer to any information associated with the performance of a computing device. As an example, as used herein, “device performance data” may include, but is not limited to applications installed on the computing, device configuration settings for installed applications, data usage of installed applications, date application was installed, processor and/or memory usage of installed applications, application crash logs, application execution and/or usage data, memory usage, processor usage, power consumption, battery usage, battery discharge rates, battery health, radio health, memory health, processor health, sensor health, display health, device settings, system log contents, application log contents, network utilization, call history information, text message history information, data transfer information, radio signals transmitted or received by the device, signal strength, overall data usage, content access by the user, device ID, device model, device operating system, device manufacturer, device sensor data, communications circuitry usage, device display usage device profile characteristics, and/or the like.

As used herein, the term “location-indicative data” may refer to any information indicative of the location of a computing device. As an example, but not limited to, “location-indicative data” may include “global positioning system (GPS) data,” “cellular data,” “Wi-Fi data.” As an example, but not limited to “GPS data,” “cellular data,” “Wi-Fi data” may include latitude, longitude, elevation, satellite ID, cellular tower data, cellular tower connection information, cellular tower ID, Wi-Fi network connection information, Wi-Fi network ID, network provider data, position relative to a reference point, heading (e.g., north, south, east, or west), Bluetooth data, online activity, social media check in activity, manually entered location information, and/or the like.

As used herein, the term “device-specific fault” may refer to any type of fault associated with a computing device. As an example, but not limited to, a “device-specific fault” may include fault with the hardware of the computing device, such as a processor fault, a memory fault, a sensor fault, a communications circuitry fault, a display fault, and/or the like. As another example, but not limited to, a “device-specific fault” may include a fault with the software of the computing device, such as application fault, operating system fault, and/or the like. As used herein, the term “location-specific fault” may include, but is not limited to, any type of fault associated with the location of the computing device. As an example, but not limited to, a “location-specific fault” may include a GPS fault, a cellular fault, a Wi-Fi fault, and/or the like.

### System Overview

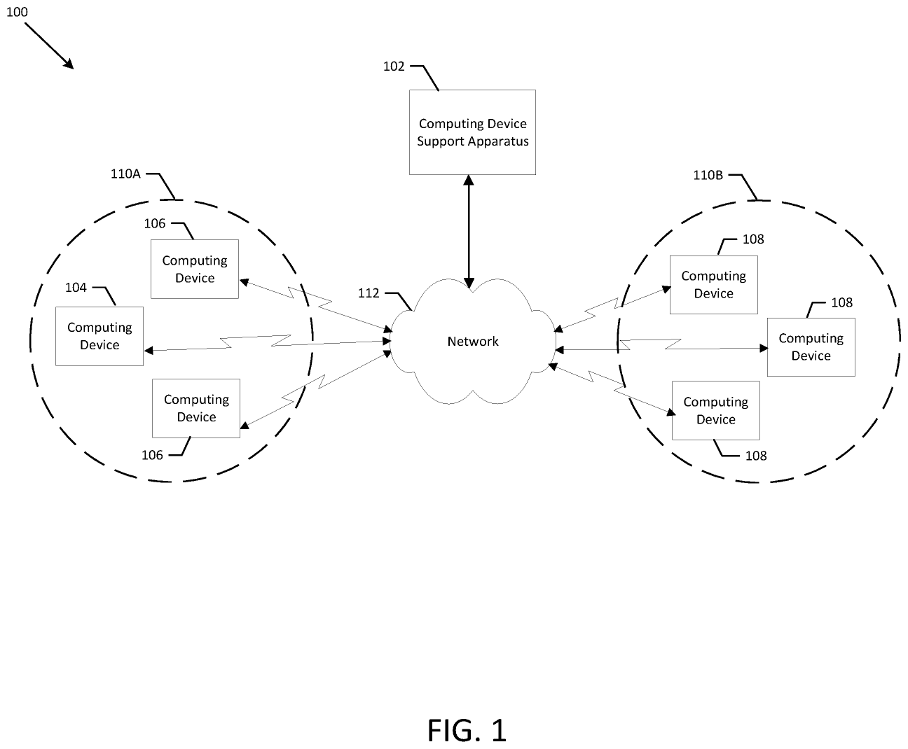

FIG. 1 illustrates a system 100 for providing computing device support services, including for identifying and differentiating between location-specific faults and device-specific faults according to some embodiments. It will be appreciated that the system 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing computing device support services, numerous other configurations may also be used to implement embodiments of the present disclosure.

The system 100 may include a computing device support apparatus 102, which may be configured to provide computing device support services to a first computing device 104 via a network 112 in accordance with one or more example embodiments disclosed herein. The computing device support apparatus 102 may comprise one or more servers, a server cluster, one or more network nodes, a cloud computing infrastructure, one or more desktop computers, one or more laptop computers, one or more mobile computing devices some combination thereof, or the like.

The system 100 may include a first computing device 104 for which computing device support services may be provided. While one such first computing device 104 is illustrated in FIG. 1, it will be appreciated that this illustration is by way of example, and not by way of limitation, as the system 100 may include additional computing devices 104 to which the system 100 may provide computing device support services. The first computing device 104 may be embodied as any computing device, such as by way of non-limiting example, a cellular phone, smart phone, communication device, tablet computing device, digital camera/camcorder, audio/video player, digital video recorder, mouse, keyboard, router, laptop computing device, desktop computing device, wearable computing device, internet of things computing device, “smart” appliances (e.g. refrigerator, washer, or dryer with network connectivity), mobile computing device, any combination thereof, any other devices whose location is capable of detection, or the like.

The system 100 may include one or more second computing devices 106. In some embodiments, a second computing device 106 may refer to devices in a first location 110A that are not the first computing device 104. While two such second computing devices 106 are illustrated in FIG. 1, it will be appreciated that this illustration is by way of example, and not by way of limitation, as the system 100 may include additional or fewer second computing devices 106. The one or more second computing devices 106 may be embodied as any computing device, such as by way of non-limiting example, a cellular phone, smart phone, communication device, tablet computing device, digital camera/camcorder, audio/video player, digital video recorder, mouse, keyboard, router, laptop computing device, desktop computing device, wearable computing device, internet of things computing device, “smart” appliances (e.g. refrigerator, washer, or dryer with network connectivity), mobile computing device, any combination thereof, any other devices whose location is capable of detection, or the like. In some embodiments, the one or more second computing devices 106 may each be the same type of computing device (e.g., the same broader category of device (such as mobile phone, laptop, wearable device, smart appliance, and/or the like) and/or the same more specific type of device (such as the same make, model, version, specific internal component, and/or the like)). In some embodiments, the one or more second computing devices 106 may be different types of computing devices. In some embodiments, a portion of the one or more second computing devices 106 may be the same type of computing devices while another portion of the one or more second computing devices 106 may be different types of computing devices. In some embodiments, the one or more second computing devices 106 may each be the same type of computing device as the first computing device 104. In some embodiments, the one or more second computing devices 106 may be different types of computing devices than the first computing device 104 and/or one or more other second computing devices 106.

As illustrated in FIG. 1, the first computing device 104 and the one or more second computing devices 106 may be in the first location 110A in accordance with one or more example embodiments disclosed herein. In some embodiments, the first computing device 104 and the one or more second computing devices 106 are in the first location 110A when within a first recognized geographical zone. As described in greater detail below, the first location 110A may be identified and/or quantified based on first location-indicative data received from the first computing device 104 and/or second location-indicative data received from the one or more second computing devices 106.

The system 100 may include one or more third computing devices 108. In some embodiments, a third computing device 108 may refer to a device that is in at least one second location 110B. While three such third computing devices 108 are illustrated in FIG. 1, it will be appreciated that this illustration is by way of example, and not by way of limitation, as the system 100 may include additional or fewer third computing devices 108. The one or more third computing devices 108 may be embodied as any computing device, such as by way of non-limiting example, a cellular phone, smart phone, communication device, tablet computing device, digital camera/camcorder, audio/video player, digital video recorder, mouse, keyboard, router, laptop computing device, desktop computing device, wearable computing device, internet of things computing device, “smart” appliances (e.g. refrigerator, washer, or dryer with network connectivity), mobile computing device, any combination thereof, any other devices whose location is capable of detection, or the like. In some embodiments, the one or more third computing devices 108 may each be the same type of computing device. In some embodiments, the one or more third computing devices 108 may be different types of computing devices. In some embodiments, a portion of the one or more third computing devices 108 may be the same type of computing devices while another portion of the one or more third computing devices 108 may be different types of computing devices.

As illustrated in FIG. 1, the one or more third computing devices 108 may be in the at least one second location 110B in accordance with one or more example embodiments disclosed herein. In some embodiments, the at least one second location 110B may be any location other than the first location 110A. In some embodiments, the one or more third computing devices 108 are in the at least one second location 110B when within a second recognized geographical zone. As described in greater detail below, the at least one second location 110B may be identified and/or quantified based on third location-indicative data received from the one or more third computing devices 108. In some embodiments, the at least one second location 110B may include a specific location or geographical zone in which all the one or more third computing devices 108 are located. In some embodiments, the one or more third computing devices 108 being in at least one second location 110B may include any device outside the first location, without requiring the one or more third computing devices 108 to each be in any same location or geographical zone. In some embodiments, the one or more third computing devices 108 may each be the same type of computing device. In some embodiments, the one or more third computing devices 108 may be different types of computing devices. In some embodiments, a portion of the one or more third computing devices 108 may be the same type of computing devices while another portion of the one or more third computing devices 108 may be different types of computing devices. In some embodiments, the one or more third computing devices 108 may each be the same type of computing device as the first computing device 104 and/or the one or more second computing device(s) 106. In some embodiments, the one or more third computing devices 108 may be different types of computing devices than the first computing device 104, the one or more second computing device(s) 106 and/or one or more other third computing devices 108.

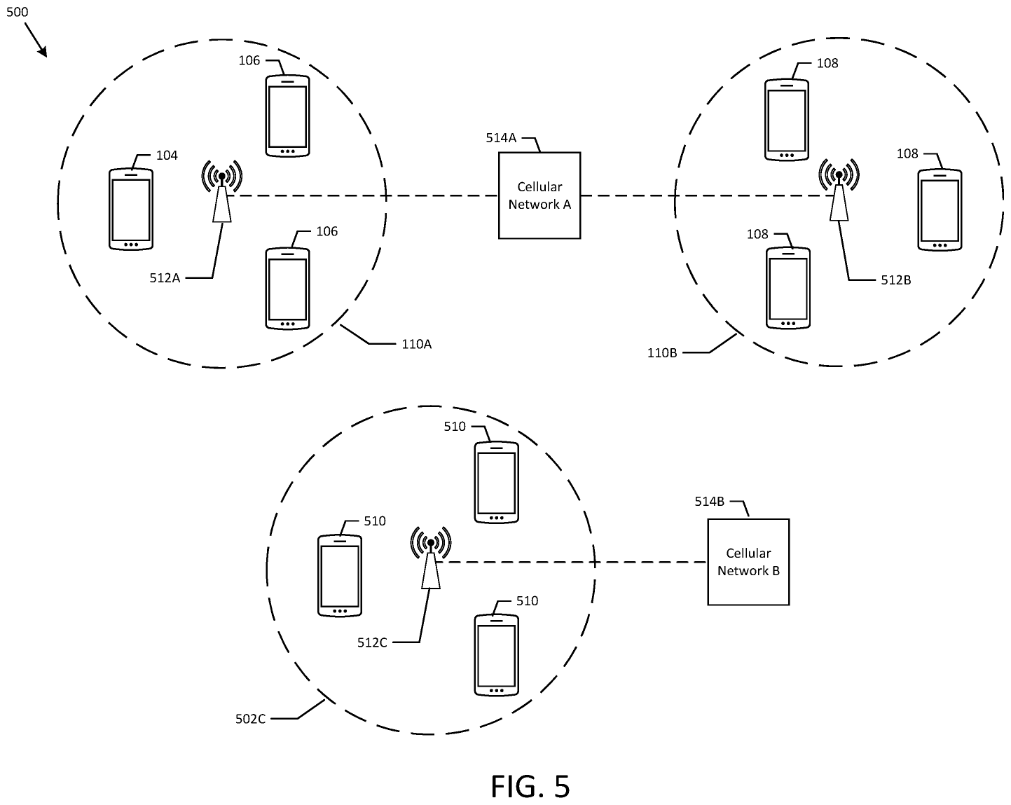

Although not shown in FIG. 1 it will be appreciated by one skilled in the art in view of the present disclosure that in some embodiments the system 100 may include additional computing devices in additional locations. For example, in some embodiments, as illustrated in FIG. 5, the system 100 may be configured to include one or more fourth computing devices 510. In some embodiments, a fourth computing device 510 may refer to a device that is in at least one third location 502C. While three such fourth computing devices 510 are illustrated in FIG. 5, it will be appreciated that this illustration is by way of example, and not by way of limitation, as the system 100 may include additional or fewer fourth computing devices 510. The one or more fourth computing devices 510 may be embodied as any computing device, such as by way of non-limiting example, a cellular phone, smart phone, communication device, tablet computing device, digital camera/camcorder, audio/video player, digital video recorder, laptop computing device, desktop computing device, wearable computing device, internet of things computing device, mobile computing device, any combination thereof, or the like. In some embodiments, the one or more fourth computing devices 510 may each be the same type of computing device. In some embodiments, the one or more fourth computing devices 510 may be different types of computing devices. In some embodiments, a portion of the one or more fourth computing devices 510 may be the same type of computing devices while another portion of the one or more fourth computing devices 510 may be different types of computing devices. In some embodiments, the one or more fourth computing devices 510 may each be the same type of computing device as the first computing device 104, the one or more second computing device(s) 106, and/or the one or more third computing device(s) 108. In some embodiments, the one or more fourth computing devices 510 may be different types of computing devices than the first computing device 104, the one or more second computing device(s) 106, the one or more third computing device(s) 108, and/or one or more other fourth computing devices 510.

As illustrated in FIG. 5, the one or more fourth computing devices 510 may be in at least one third location 502C in accordance with one or more example embodiments disclosed herein. In some embodiments, the at least one third location 502C may be any location other than the first location 110A and, in some embodiments, other than the second location 110B . In some embodiments, the one or more fourth computing devices 510 are in the at least one third location 502C when within a third recognized geographical zone. As described in greater detail below, the at least one third location 502C may be identified and/or quantified based on fourth location-indicative data received from the one or more fourth computing devices 510. For example, in some embodiments, the size of the third recognized geographical zone may be determined based on the fourth location-indicative data (e.g., a predetermined radius, a certain coverage area, a certain common connection type or connection link, or the like). It should also be understood that numerical references such as “first computing device”, “second computing device”, and the like are solely intended to differentiate the devices with respect to the distinctions noted in the specification for ease of comprehension (e.g., in some embodiments, the “first” device may be in a different location than the “third devices”); however, such terminology should not be interpreted as conveying any other limitation or requirement on the form, function, or other property of the devices.

In various example embodiments, the first computing device 104, the one or more second computing devices 106, and the one or more third computing devices 108 may be configured to connect to one or more networks 112 via a variety of wireless and/or wireline connections. For example, the first computing device 104, the one or more second computing devices 106, and the one or more third computing devices 108 may be configured to access the network 112 via a cellular connection, wireless local area network connection, Ethernet connection, and/or the like. As such, the network 112 may comprise a wireline network, wireless network (e.g., a cellular network, wireless local area network, wireless wide area network, some combination thereof, or the like), or a combination thereof, and in some example embodiments comprises at least a portion of the Internet. Likewise, the computing device support apparatus 102 may connect to the one or more networks 112 and may receive any of the data and other information disclosed herein directly or indirectly from the various computing devices, including via one or more intermediary computing systems (not shown).

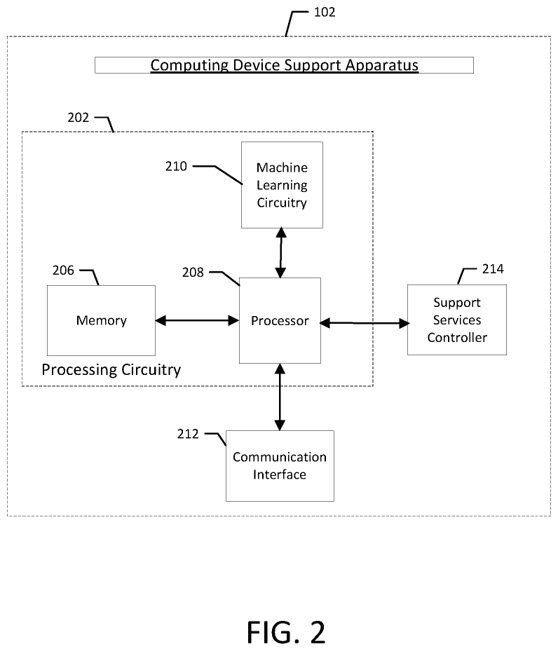

FIG. 2 illustrates a block diagram of a computing device support apparatus 102 in accordance with some example embodiments. However, it should be noted that the components, devices or elements illustrated in and described with respect to FIG. 2 below may not be mandatory and thus one or more may be omitted in certain embodiments. Additionally, some embodiments may include further or different components, devices or elements beyond those illustrated in and described with respect to FIG. 2.

The computing device support apparatus 102 may be embodied as any computing device or devices, such as by way of non-limiting example a cellular phone, smart phone, communication device, tablet computing device, desktop computing device, mobile computing device, server or serve network, remote computing device, distributed cloud computing system, kiosks, input terminals, any combination thereof, or the like.

The computing device support apparatus 102 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the computing device support apparatus 102 in accordance with various example embodiments, and thus may provide means for performing functionalities of the computing device support apparatus 102 in accordance with various example embodiments. The processing circuitry 202 may be configured to perform data processing, application execution and/or other processing and management services according to one or more example embodiments. In some embodiments, the computing device support apparatus 102 or a portion(s) or component(s) thereof, such as the processing circuitry 202, may be embodied as or comprise a chip or chip set. In other words, the computing device support apparatus 102 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The computing device support apparatus 102 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein

In some example embodiments, the processing circuitry 202 may include a processor 208 and, in some embodiments, such as that illustrated in FIG. 2, may further include memory 206 and machine learning circuitry 210. The processing circuitry 202 may be in communication with or otherwise control a communication interface 212 and/or a support services controller 214. As such, the processing circuitry 202 may be embodied as a circuit chip (e.g., an integrated circuit chip) configured (e.g., with hardware, software or a combination of hardware and software) to perform operations described herein.

The processor 208 may be embodied in a number of different ways. For example, the processor 208 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 208 may comprise a plurality of processors. The plurality of processors may be in operative communication with each other and may be collectively configured to perform one or more functionalities of the computing device support apparatus 102 as described herein. The plurality of processors may be embodied on a single computing device or distributed across a plurality of computing devices collectively configured to function as the computing device support apparatus 102. In some example embodiments, the processor 208 may be configured to execute instructions stored in the memory 206 or otherwise accessible to the processor 208. As such, whether configured by hardware or by a combination of hardware and software, the processor 208 may represent an entity (e.g., physically embodied in circuitry—in the form of processing circuitry 202) capable of performing operations according to embodiments of the present disclosure while configured accordingly. Thus, for example, when the processor 208 is embodied as an ASIC, FPGA or the like, the processor 208 may be specifically configured hardware for conducting the operations described herein. Alternatively, as another example, when the processor 208 is embodied as an executor of software instructions, the instructions may specifically configure the processor 208 to perform one or more operations described herein.

In some example embodiments, the memory 206 may include one or more non-transitory memory devices such as, for example, volatile and/or non-volatile memory that may be either fixed or removable. In this regard, the memory 206 may comprise a non-transitory computer-readable storage medium. It will be appreciated that while the memory 206 is illustrated as a single memory, the memory 206 may comprise a plurality of memories. The plurality of memories may be embodied on a single computing device or may be distributed across a plurality of computing devices collectively configured to function as the computing device support apparatus 102. The memory 206 may be configured to store information, data, applications, instructions and/or the like for enabling the computing device support apparatus 102 to carry out various functions in accordance with one or more example embodiments. For example, the memory 206 may be configured to buffer input data for processing by the processor 208. Additionally or alternatively, the memory 206 may be configured to store instructions for execution by the processor 208. As yet another alternative, the memory 206 may include one or more databases that may store a variety of files, contents or data sets. Among the contents of the memory 206, applications may be stored for execution by the processor 208 in order to carry out the functionality associated with each respective application. In some cases, the memory 206 may be in communication with one or more of the processor 208, communication interface 212, the machine learning circuitry 210 or support services controller 214 via a bus(es) for passing information among components of the computing device support apparatus 102.

In some example embodiments, the machine learning circuitry 210 may include hardware components designed or configured to request, receive, process, generate, and transmit data, data structures, control signals, and electronic information for executing a trained machine learning model to identify and differentiate between location-specific faults and device-specific faults, such as by evaluating device status data received from the first computing device 104, the one or more second computing devices 106, and/or the one or more third computing devices 108. In some example embodiments, the memory 206 may be in communication with one or more of the memory 206, the processor 208, the communication interface 212, or the support services controller 214 via a bus(es) for passing information among components of the computing device support apparatus 102.

In some example embodiments, the computing device support apparatus 102 may further include a communication interface 212. In some cases, the communication interface 212 may be any means such as a device or circuitry embodied in either hardware, or a combination of hardware and software that is configured to receive and/or transmit data from/to a network and/or any other device or circuitry in communication with the processing circuitry 202. By way of example, the communication interface 212 may be configured to enable the computing device support apparatus 102 to communicate with the first computing device 104, the one or more second computing devices 106, the one or more third computing devices 108, and/or other computing device via the network 112. Accordingly, the communication interface 212 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the computing device support apparatus 102 may be embodied as, include, or otherwise control a support services controller 214. As such, the support services controller 214 may be embodied as various means, such as circuitry, hardware, a computer program product comprising computer readable program instructions stored on a computer readable medium (for example, the memory 206) and executed by a processing device (for example, the processor 208), or some combination thereof. The support services controller 214 may be capable of communication with one or more of the memory 206 or communication interface 212 to access, receive, and/or send data as may be needed to perform one or more of the functionalities of the support services controller 214 as described herein.

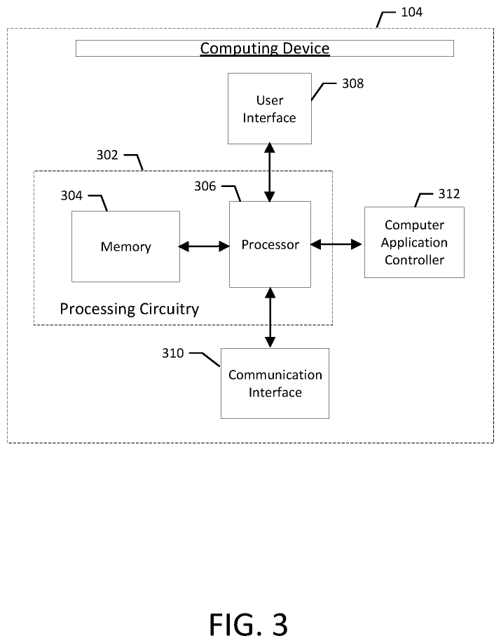

FIG. 3 illustrates a block diagram of a first computing device 104 in accordance with some example embodiments. However, it should be noted that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3. Although not separately labeled in FIG. 3, it should be noted that the one or more second computing devices 106 and the one or more third computing devices 108 may include the same or similar components, devices, or elements as those described below with respect to the first computing device 104 of FIG. 3. Additionally, in some embodiments, the one or more second computing devices 106 and the one or more third computing devices 108 may include further or different components, devices or elements beyond those described with respect to FIG. 3 including dedicated circuitry (e.g., hardware, software, and/or combinations thereof) for achieving any of the operations and functionalities described herein.

Referring now to FIG. 3, a block diagram of the first computing device 104 is illustrated. As described above the first computing device 104 may be embodied as any computing device, such as by way of non-limiting example, a cellular phone, smart phone, communication device, tablet computing device, digital camera/camcorder, audio/video player, digital video recorder, mouse, keyboard, router, laptop computing device, desktop computing device, wearable computing device, internet of things computing device, “smart” appliances (e.g. refrigerator, washer, or dryer with network connectivity), mobile computing device, any combination thereof, any other devices whose location is capable of detection, or the like.

The first computing device 104 may include or otherwise be in communication with processing circuitry 302 that is configurable to perform actions in accordance with one or more example embodiments disclosed herein. In this regard, the processing circuitry 302 may be configured to perform and/or control performance of one or more functionalities of the first computing device 104 in accordance with various example embodiments, and thus may provide means for performing functionalities of the first computing device 104 in accordance with various example embodiments. The processing circuitry 302 may be configured to perform data processing, application execution and/or other processing and management services according to one or more example embodiments. In some embodiments, the first computing device 104 or a portion(s) or component(s) thereof, such as the processing circuitry 302, may be embodied as or comprise a chip or chip set. In other words, the first computing device 104 or the processing circuitry 302 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The first computing device 104 or the processing circuitry 302 may therefore, in some cases, be configured to implement an embodiment of the disclosure on a single chip or as a single “system on a chip.” As such, in some cases, a chip or chipset may constitute means for performing one or more operations for providing the functionalities described herein.

In some example embodiments, the processing circuitry 302 may include a processor 306 and, in some embodiments, such as that illustrated in FIG. 3, may further include memory 304. The processing circuitry 302 may be in communication with or otherwise control a user interface 308, a communication interface 310, and/or a computer application controller 312. As such, the processing circuitry 302 may be embodied as a circuit chip (e.g., an integrated circuit chip) configured (e.g., with hardware, software or a combination of hardware and software) to perform operations described herein.

The processor 306 may be embodied in a number of different ways. For example, the processor 306 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 306 may comprise a plurality of processors. The plurality of processors may be in operative communication with each other and may be collectively configured to perform one or more functionalities of the first computing device 104 as described herein. In some example embodiments, the processor 306 may be configured to execute instructions stored in the memory 304 or otherwise accessible to the processor 306. As such, whether configured by hardware or by a combination of hardware and software, the processor 306 may represent an entity (e.g., physically embodied in circuitry—in the form of processing circuitry 302) capable of performing operations according to embodiments of the present disclosure while configured accordingly. Thus, for example, when the processor 306 is embodied as an ASIC, FPGA or the like, the processor 306 may be specifically configured hardware for conducting the operations described herein. Alternatively, as another example, when the processor 306 is embodied as an executor of software instructions, the instructions may specifically configure the processor 306 to perform one or more operations described herein.

In some example embodiments, the memory 304 may include one or more non-transitory memory devices such as, for example, volatile and/or non-volatile memory that may be either fixed or removable. In this regard, the memory 304 may comprise a non-transitory computer-readable storage medium. It will be appreciated that while the memory 304 is illustrated as a single memory, the memory 304 may comprise a plurality of memories. The memory 304 may be configured to store information, data, applications, instructions and/or the like for enabling the first computing device 104 to carry out various functions in accordance with one or more example embodiments. For example, the memory 304 may be configured to buffer input data for processing by the processor 306. Additionally or alternatively, the memory 304 may be configured to store instructions for execution by the processor 306. As yet another alternative, the memory 304 may include one or more databases that may store a variety of files, contents or data sets. Among the contents of the memory 304, applications may be stored for execution by the processor 306 in order to carry out the functionality associated with each respective application. In some cases, the memory 304 may be in communication with one or more of the processor 306, user interface 308, communication interface 310, or computer application controller 312 via a bus(es) for passing information among components of the first computing device 104.

The user interface 308 may be in communication with the processing circuitry 302 to receive an indication of a user input at the user interface 308 and/or to provide an audible, visual, mechanical or other output to the user. As such, the user interface 308 may include, for example, a keyboard, a mouse, a joystick, a display, a touch screen display, a microphone, a speaker, and/or other input/output mechanisms. As such, the user interface 308 may, in some example embodiments, provide means for a user to access and interact with computing device support services provided by the computing device support apparatus 102 in accordance with various example embodiments.

The communication interface 310 may include one or more interface mechanisms for enabling communication with other devices and/or networks. In some cases, the communication interface 310 may be any means such as a device or circuitry embodied in either hardware, or a combination of hardware and software that is configured to receive and/or transmit data from/to a network and/or any other device or module in communication with the processing circuitry 302. By way of example, the communication interface 310 may be configured to enable the first computing device 104 to communicate with the computing device support apparatus 102 and/or other computing device via the network 112. Accordingly, the communication interface 310 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

In some example embodiments, the processor 306 (or the processing circuitry 302) may be embodied as, include, or otherwise control a computer application controller 312. As such, the computer application controller 312 may be embodied as various means, such as circuitry, hardware, a computer program product comprising computer readable program instructions stored on a computer readable medium (for example, the memory 304) and executed by a processing device (for example, the processor 306), or some combination thereof. The computer application controller 312 may be capable of communication with one or more of the memory 304, user interface 308, or communication interface 310 to access, receive, and/or send data as may be needed to perform one or more of the functionalities of the computer application controller 312 as described herein. In accordance with some example embodiments, the computer application controller 312 may provide means for implementing and controlling functionality of a computer application that may be configured to interact with the computing device support apparatus 102, assist the computing device support apparatus 102 in providing computing device support services, and/or assist with performing fault identification for the first computing device 104 in accordance with various example embodiments.

Having now generally described several embodiments of the system 100, computing device support services, including for identifying and differentiating between location-specific faults and device-specific faults associated with the first computing device 104 will now be described in accordance with several example embodiments.

### Fault Identification

Some example embodiments offer location aware computing device support services, including for identifying and differentiating between location-specific faults and device-specific faults associated with the first computing device 104. In accordance with various example embodiments, these services may, for example, be provided by the computing device support apparatus 102, using a trained machine learning model executed by the machine learning circuitry 210, under the control of the support services controller 214.

### Device Status Data Collection

In some example embodiments, in order to facilitate the offering of computing device support services, including for identifying and differentiating between location-specific faults and device-specific faults associated with the first computing device 104, the computing device support apparatus 102 may be configured to monitor, collect, and store device status data. In some embodiments, the computing device support apparatus 102 may be configured to monitor, collect, and store first device status data from the first computing device 104, second device status data from the one or more second computing devices 106, third device status data from the one or more third computing devices 108, and/or data from one or more additional devices or sets of devices. In some embodiments, device status data may include device performance data according to any of the various embodiments discussed herein. Additionally or alternatively, device status data may include location-indicative data. While the discussion in this section primarily refers to various methods and protocols for collecting and storing the first device status data from the first computing device 104 by the computing device support apparatus 102, similar methods and protocols may be used for collecting and storing the second device status data from the one or more second computing devices 106 and/or third device status data from the one or more third computing devices 108. Additionally or alternatively, the computing device support apparatus 102 may use alternate or additional methods for collecting and storing of the second device status data from the one or more second computing devices 106 and/or the third device status data from the one or more third computing devices 108.

In some embodiments, a user may register for, or opt-in to, receiving computing device support services according to various embodiments disclosed herein, including for identifying and differentiating between location-specific faults and device-specific faults associated with the first computing device 104 from the computing device support apparatus 102. Registration in some example embodiments may, for example, comprise a proactive user action of registering via a web portal, such as may be provided by the computing device support apparatus 102 and accessible via a first computing device 104, registering via a computer application that may be implemented on the first computing device 104, and/or the like. As another example, in some example embodiments, registration may occur automatically responsive to user enrollment in a device protection plan for the first computing device 104, purchase of a device warranty for the first computing device 104, purchase of the first computing device 104, and/or the like.

In some embodiments, registration information may be provided by the user and/or otherwise determined during the registration process, such as by the machine learning circuitry 210, the support services controller 214, and/or computer application controller 312. This registration information, in some embodiments, may comprise information enabling and/or otherwise configuring the provision of computing device support services, including for identifying and differentiating between location-specific faults and device-specific faults. The registration information may, for example, include first device status data such as first device performance data and first location-indicative data. For example, the registration information may include first device performance data including device ID, device model, device operating system, device manufacture, user account information, and/or the like.

In some embodiments, the computing device support apparatus 102 via at least the support services controller 214 may be configured to collect first device status data from the first computing device 104. In some embodiments, the support services controller 214 may be assisted by the computer application controller 312 of the first computing device 104. The collecting of the first device status data may, for example, be performed in real-time, periodically, on an ongoing basis, aperiodically, in accordance with a schedule, on demand, in accordance with configuration settings defined by a user of the first computing device 104, in accordance with configuration settings defined by an operator or controller of the computing device support apparatus 102, in accordance with configuration settings defined by the machine learning circuitry 210, and/or the like.

For example, the computing device support apparatus 102 may be configured to proactively monitor and collect first device status data from the first computing device 104. In this way, the computing device support apparatus 102 may be configured to proactively look for faults associated with the first computing device 104. As another example, collecting may be configured to capture only some type(s) of first device status data and/or capture only some type(s) of first device status data when certain conditions are met. For example, the computing device support apparatus 102 may be configured to initially collect first device status data comprising an indication of at least one fault from the first computing device 104. In this regard, after receiving first device status data comprising an indication of at least one fault, the computing device support apparatus 102 may collect other first device status data from the first computing device 104. As another example, the collecting may be configured to only capture specific first device performance data that may be beneficial in identifying a particular fault. As another example, the collecting may be configured to only capture first location-indicative data when the first computing device 104 is in a particular location, connected to a particular cellular or Wi-Fi network, and/or the like. As another example, the computing device support apparatus 102 may be configured to collect first device status data from the first computing device 104 on-demand in response to a user and/or an operator request. For example, the collecting may be in accordance with privacy settings and/or a privacy policy agreed to by the user. As another example, collecting may be configured to occur during periods of low utilization of the first computing device 104 and/or the computing device support apparatus 102, such as overnight and/or when there is free server capacity. As another example, collecting may be configured to be performed during periods in which the first computing device 104 is connected to an external power resource, such as when a battery of the first computing device 104 may be charging.

In some embodiments, collection of first device status data may, for example, be performed with the assistance of one or more sensors that may be implemented on the first computing device 104 and/or that may otherwise be queried by the first computing device 104. By way of non-limiting example, these sensors may include a touch screen sensor, key actuation sensor (e.g., for a keypad/keyboard), Global Positioning System (GPS) sensor, accelerometer, battery level sensor, battery capacitance sensor, battery temperature sensor, network signal strength sensor, and/or the like.

In some embodiments, the first device status data collected from the first computing device 104 may be used to determine a device profile associated with the first computing device 104. In some embodiments, the device profile associated with the first computing device 104 may comprise a record of all the first device status data associated with the first computing device 104. In some embodiments, the device profile may comprise one or more characteristics associated with the first computing device 104. In some embodiments, machine learning techniques may be performed on the captured first device status data by the machine learning circuitry 210 to determine the one or more characteristics associated with the first computing device 104. In some embodiments, the device profile may be maintained, such as in the memory 206 and/or in the memory 304. In some embodiments, the device profile maintained in the memory 206 and/or the memory 304 may be updated on an ongoing basis, aperiodically, in accordance with a schedule, on demand, in accordance with user configurations, and/or the like as more first device status data is collected from the first computing device 104. In some embodiments, the device profile maintained in the memory 206 and/or the memory 304 may be used for identifying and differentiating between location-specific faults and device-specific faults associated with the first computing device 104.

### Device Status Data Aggregation

As described above, the computing device support apparatus 102 may be configured to collect second device status data from the one or more second computing devices 106 and collect third device status data from the one or more third computing devices 108. In some embodiments, the one or more second computing devices 106 and the one or more third computing devices 108 may include computing devices upon which the computing device support apparatus 102 has previously provided, and/or is currently providing, computing device support services to for identifying and differentiating between location-specific faults and device-specific faults. Additionally or alternatively, the one or more second computing devices 106 and the one or more third computing devices 108 may include computing devices the computing device support apparatus 102 has not previously provided, and/or is not currently providing computing device support services.

In some embodiments, the second device status data may comprise device status data associated with only one of the one or more second computing devices 106. Additionally or alternatively, in some embodiments, the second device status data may comprise device status data associated with more than one of the one or more second computing devices 106. In other words, in some embodiments, the computing device support apparatus 102 may identify and differentiate between location-specific faults and device-specific faults associated with the first computing device 104 using second device status data associated with only one of the one or more second computing devices 106 and/or using second device status data associated with more than one of the one or more second computing devices 106. Similarly, in some embodiments, the third device status data may comprise device status data associated with only one of the one or more third computing devices 108. Additionally or alternatively, in some embodiments, the third device status data may comprise device status data associated with more than one of the one or more third computing devices 108. In other words, in some embodiments, the computing device support apparatus 102 may identify and differentiate between location-specific faults and device-specific faults associated with the first computing device 104 using third device status data associated with only one of the one or more third computing devices 108 and/or using third device status data associated with more than one of the one or more third computing devices 108. In some embodiments, second and third devices may be included in a single dataset or plurality of datasets and differentiated either in the dataset or via collecting separate datasets.

In some embodiments, the computing device support apparatus 102 may create a plurality of historical device status datasets from the second device status data and third device status data (e.g., one or more aggregated data sets). In some embodiments, the plurality of historical device status datasets may include historical location-indicative datasets. For example, the historical location-indicative datasets may be formed from a plurality of the computing devices experiencing a location-specific fault in one or more locations. In some embodiments, the historical location-indicative datasets may be divided into historical device status datasets for particular types of location-specific faults (e.g. a fault associated with a cellular network). In some embodiments, the plurality of historical device status datasets may include historical device performance datasets. For example, the historical device performance datasets may be formed from a plurality of computing devices experiencing a device-specific fault. In some embodiments, the historical device performance datasets may be divided into historical device status datasets for particular types of device-specific faults (e.g. a weak battery, defective radio, etc.). In some embodiments, the plurality of historical device status datasets may include historical device status datasets for particular models or types of computing devices (e.g. computing devices with an Android operating system). In some embodiments, and as described in greater detail below, the plurality of historical device status datasets may be used to train a machine learning model that may be executed by machine learning circuitry 210 to identify and differentiate between device-specific faults and/or location-specific faults. In some embodiments, the historical device status datasets may be stored and categorized from a time or dataset that triggered detection of the device-specific fault and/or location-specific fault. In some embodiments, faults diagnosed by the model are fed back into the historical device status datasets as further training data, which may be subject to review and/or verification prior to inclusion.

Location Identification

As described above, in some embodiments the computing device support apparatus 102 may determine that the first computing device 104 and the one or more second computing devices 106 may be in a first location 110A or may have previously been in the first location 110A, such that device status data associated with the first location 110A is available for the device(s) (e.g. the device status data may be presently provided device status data and/or historical device status data). In some embodiments, the first computing device 104 and/or the one or more second computing devices 106 may be determined to be in the first location 110A when within a first recognized geographical zone. As used herein, a “geographical zone” may refer to an area determined to be at a particular “location” (e.g., the first location 110A may encompass an area greater than a single infinitesimal point, such as a predetermined radius around a certain coordinate location, all locations within range of a cellular tower or satellite, all locations within range of a wireless router(s), or any other means of differentiating one physical area from another). In some embodiments, the first location 110A may be identified and/or quantified based on the first location-indicative data received from the first computing device 104 and/or the second location-indicative data received from the one or more second computing devices 106. For example, the first location 110A may be based off of the location of the first computing device 104, such that the first computing device 104 is at the center of first location 110A (e.g. at the center of the first recognized geographical zone). In some such embodiments, the models described herein may be trained relative to the actual location of the first computing device 104. In some embodiments, models may be trained for predetermined recognized geographic regions, and a particular pre-trained model may be selected by selecting the closest pre-trained model to the actual location of the first computing device 104. As another example, in some embodiments, the size of the first recognized geographical zone may be determined based on the first location-indicative data (e.g., a predetermined radius, a certain coverage area, a certain common connection type or connection link, or the like). Similarly, in some embodiments and as described above, the computing device support apparatus 102 may determine that the one or more third computing devices 108 may be in at least one second location 110B. In some embodiments, the one or more third computing devices 108 are in the at least one second location 110B when within a second recognized geographical zone. In some embodiments, the at least one second location 110B may be any location other than the first location 110A. In some embodiments, the at least one second location 110B may be identified and/or quantified based on the third location-indicative data received from the one or more third computing devices 108. For example, in some embodiments, the size of the second recognized geographical zone may be determined based on the second location-indicative data (e.g., a predetermined radius, a certain coverage area, a certain common connection type or connection link, or the like). In some such embodiments, the models described herein may be trained relative to the actual location of one or more second computing devices 106, by selecting an average or grouping of two or more second computing devices 106, and/or by selecting a region outside of the first location. In some embodiments, models may be trained for predetermined recognized geographic regions, and a particular pre-trained model may be selected by selecting the closest pre-trained model to the actual location of the second computing device or selecting the closest pre-trained model that does not include the actual location of the first computing device.

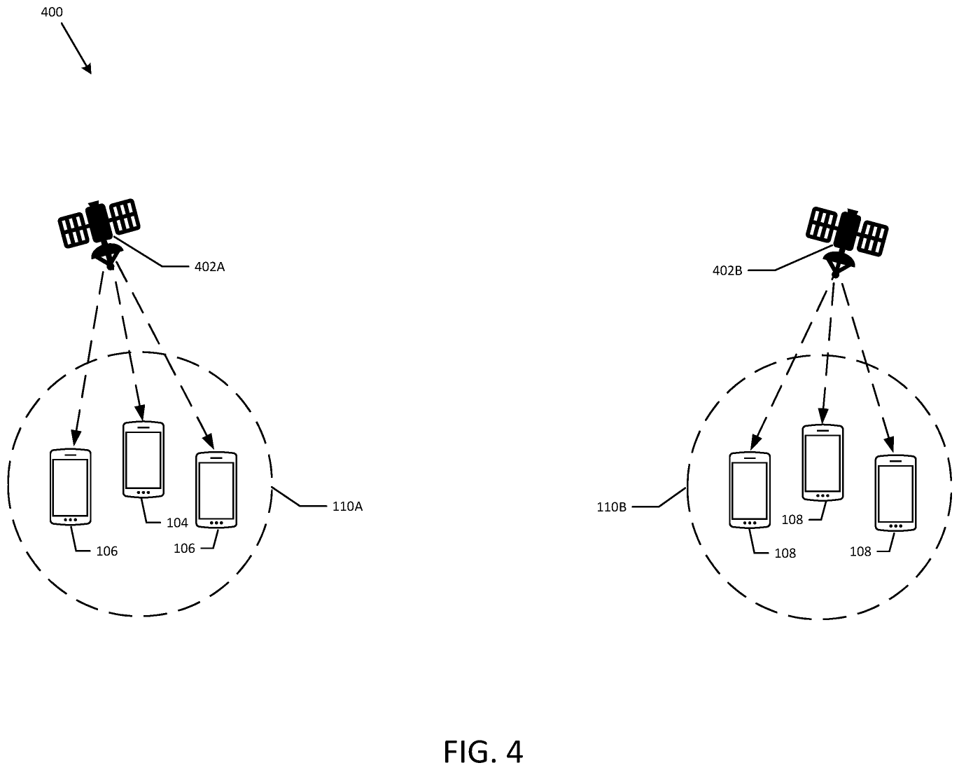

As illustrated in the example embodiment of FIG. 4, the computing device support apparatus 102 may determine that the first computing device 104 and/or the one or more second computing devices 106 are in the first location 110A, based on first location-indicative data and/or second location-indicative data comprising GPS data. For example, the first location-indicative data and/or the second location-indicative data may indicate that the first computing device 104 and the one or more second computing devices 106 are at particular coordinates within a predetermined range of each other. As another example, the first location-indicative data and/or the second location-indicative data may indicate that the first computing device 104 and the one or more second computing devices 106 are within the range of, or communicating with, a first satellite 402A. Similarly, as illustrated in the example embodiment of FIG. 4, the computing device support apparatus 102 may determine that the one or more third computing devices 108 are in the at least one second location 110B, based on the third location-indicative data comprising GPS data. For example, the third location-indicative data may indicate that the one or more third computing devices 108 are at particular coordinates within a predetermined range of each other. As another example, the third location-indicative data may indicate that the one or more third computing devices 108 are within the range of, or communicating with, a second satellite 402B. In some embodiments, a plurality of satellites may be considered (e.g., devices within range of two, three, four, five, six, or more satellites may be determined to be within the same location). For example, GPS location may be triangulated based on a plurality of satellites in connection with a particular device, and the combination of connected satellites and/or the range to the satellites may determine the location.

As illustrated in the example embodiment of FIG. 5, the computing device support apparatus 102 may determine that the first computing device 104 and the one or more second computing devices 106 are in the first location 110A, based on first location-indicative data and/or second location-indicative data comprising cellular data. For example, the first location-indicative data and/or the second location-indicative data may indicate that the first computing device 104 and the one or more second computing devices 106 are at particular coordinates within a predetermined range of each other. As another example, the first location-indicative data and/or the second location-indicative data may indicate that the first computing device 104 and the one or more second computing devices 106 are within the range of, or communicating with, a first cellular tower 512A Similarly, as illustrated in the example embodiment of FIG. 5, the computing device support apparatus 102 may determine that the one or more third computing devices 108 are in the at least one second location 110B, based on the third location-indicative data comprising cellular data. For example, the third location-indicative data may indicate that the one or more third computing devices 108 are at particular coordinates within a predetermined range of each other. As another example, the third location-indicative data may indicate that the one or more third computing devices 108 are within the range of, or communicating with, a second cellular tower 512B. In some embodiments, the first cellular tower 512A and the second cellular tower 512B may belong to a common cellular network, such as cellular network A 512A. In some embodiments, a plurality of cellular towers may be considered (e.g., devices within range of two, three, four, five, six, or more towers may be determined to be within the same location). For example, cellular location may be triangulated based on a plurality of cellular towers in connection with a particular device, and the combination of connected towers may determine the approximate location.

As illustrated in the example embodiment of FIG. 5, the computing device support apparatus 102 may also be configured to determine that one or more fourth computing devices 510 are in the at least one third location 502C or may have previously been in the at least one third location 502C, such that device status data associated with the at least one third location 502C is available for the device(s) (e.g. the device status data may be presently provided device status data and/or historical device status data). In some embodiments, one or more fourth computing devices 510 may be determined to be in the at least one third location 502C when in a third recognized geographical zone. The at least one third location 502C may be identified and/or quantified based on the fourth location-indicative data received from the one or more fourth computing devices 510. For example, in some embodiments, the size of the third recognized geographical zone may be determined based on the fourth location-indicative data (e.g., a predetermined radius, a certain coverage area, a certain common connection type or connection link, or the like). For example, the fourth location-indicative data may indicate that the one or more fourth computing devices 510 are at particular coordinates within a predetermined range of each other. As another example, the fourth location-indicative data may indicate that the one or more fourth computing devices 510 are within the range of, or communicating with, a third cellular tower 512C. In some embodiments, the third cellular tower 512C may belong to a different cellular network, such as cellular network B 514B, than the first cellular tower 512A and the second cellular tower 512B.

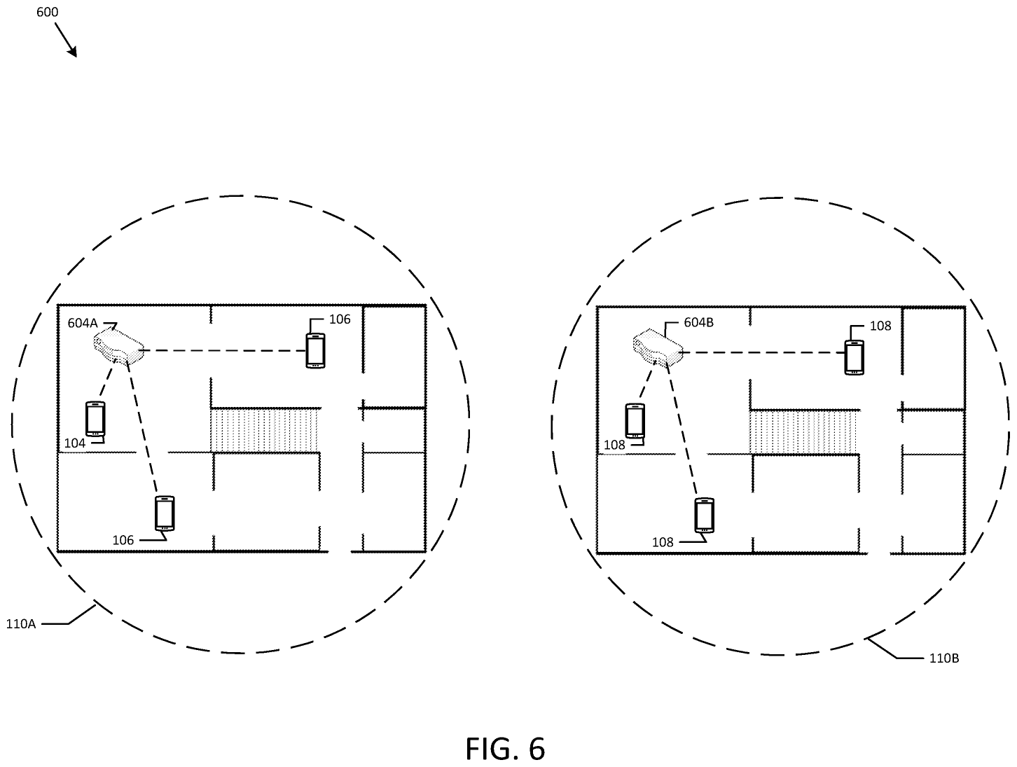

As illustrated in the example embodiment of FIG. 6, the computing device support apparatus 102 may determine that the first computing device 104 and the one or more second computing devices 106 are in the first location 110A, based on first location-indicative data and/or second location-indicative data comprising Wi-Fi data. For example, the first location-indicative data and/or the second location-indicative data may indicate that the first computing device 104 and the one or more second computing devices 106 are within the range of, or communicating with, a first Wi-Fi device 604A (e.g., a first Wi-Fi router). In some embodiments, the first Wi-Fi device 604A may be configured to provide Wi-Fi coverage for one floor of a house or an office building. Similarly, as illustrated in the example embodiment of FIG. 6, the computing device support apparatus 102 may determine that the one or more third computing devices 108 are in the at least one second location 110B, based on the third location-indicative data comprising Wi-Fi data. For example, the third location-indicative data may indicate that the one or more third computing devices 108 are within the range of, or communicating with, a second Wi-Fi device 604B (e.g., a second Wi-Fi router). In some embodiments, the second Wi-Fi device 604B may be configured to provide Wi-Fi coverage for a different floor in the house or the office building.

Although several examples are shown herein, any other method of differentiating locations and data sources for location may be used to identify the data associated with the first, second, third, and any other devices.

### Proactive Identification of Device Faults

In some embodiments, the computing device support apparatus 102, for example using the processor 208, the trained machine learning model executed by the machine learning circuitry 210, and/or other components of the computing device support apparatus 102, may facilitate the proactive identification of device faults that may be affecting the first computing device 104. For example, the computing device support apparatus 102 may receive first device performance data from the first computing device 104. In some embodiments, the computing device support apparatus 102 may determine that received first device performance data comprises an anomalous data point indicating that the first computing device 104 is affected by a fault. In some embodiments, in response to determining that the first computing device 104 is affected by a fault, the computing device support apparatus 102 may determine if the first computing device 104 is affected by a device-specific fault or a location-specific fault (e.g. determining if the anomalous data point indicating that the first computing device 104 is affected by a fault is being caused by a fault associated with a device or system other than the first computing device 104 or a fault that is occurring on the first computing device 104). In some embodiments, the computing device support apparatus 102 and/or the first computing device 104 may detect a location associated with the first computing device 104, determine that the location is associated with one or more performance faults, and proactively warn the user before or during the occurrence of the fault. In some embodiments, an application executing on the first computing device 104 may receive instructions from the computing device support apparatus 102 and/or may include pre-programmed instructions on the first computing device 104 to identify one or more of the device-specific or location-specific faults discussed herein.

### Identification and Differentiation Between Location-Specific Faults and Device-Specific Faults

In some embodiments, the computing device support apparatus 102, for example using the processor 208, the trained machine learning model executed by the machine learning circuitry 210, and/or other components of the computing device support apparatus 102, may facilitate the identification and/or differentiation of location-specific faults and device-specific faults that may be affecting the first computing device 104. In some embodiments, the computing device support apparatus 102 may identify and differentiate between location-specific faults and/or device-specific faults. In some embodiments, a location-specific fault may be a fault that is experienced by at least one other computing device (e.g., other than the first computing device 104) in a location, such as the first location 110A in accordance with the processes described herein. In some embodiments, the identified fault (e.g., an actual fault or potential fault) which is determined to be a location-specific fault may be determined not to be an actual fault with the computing device. For example, the geography, infrastructure that supports the first computing device 104, or other factors not primarily caused by the first computing device 104 itself may create a performance issues (e.g. a drop in performance of the first computing device 104) indicative of a perceived fault with the first computing device 104. The computing device support apparatus 102 may then (e.g., using a trained machine learning model executed by the machine learning circuitry 210 comparing the first computing device with other devices in the same and different locations) determine that the performance issue is caused, in whole or in part, by the location (e.g., the geography, infrastructure, or other factors discussed above).

In some embodiments, the location-specific fault may be a fault caused by a device or system other than the first computing device 104 but experienced by the first computing device 104. For example, the location-specific fault may be one or more of a geographical fault, a global positioning system fault, a Wi-Fi fault, and/or a cellular fault, such as a fault associated with a global positioning system satellite or network, a cellular tower or network, and/or a Wi-Fi device or network. In some embodiments, a device-specific fault may be a fault that is occurring on the first computing device 104, such as a software fault or a hardware fault on the first computing device 104.

In some embodiments, the computing device support apparatus 102, for example using the trained machine learning model executed by the machine learning circuitry 210, may identify and differentiate between location-specific faults and/or device-specific faults affecting the first computing device 104 by comparing the first device status data from the first computing device 104 against the second device status data from the one or more second computing devices 106 (e.g., via a machine learning model trained from the historical device status datasets). For example, in some embodiments, the computing device support apparatus 102 may compare some or all of the first device performance data against some or all of second device performance data. Additionally or alternatively, the computing device support apparatus 102 may compare particular first device performance data (e.g., signal strength of the first computing device 104) against corresponding second device performance data (e.g., signal strength of the one or more second computing devices 106). In some embodiments, if the first device performance data is substantially equivalent to the second device performance data the first device performance was compared against (e.g., the first device performance data indicates a performance issue with the first computing device 104 and the second device performance data indicates a similar performance issue with the one or more second computing devices 106 at the same location), the computing device support apparatus 102 may determine that the first computing device 104 has a location-specific fault, which may, in some embodiments, be determined not to be a device-specific fault (e.g., not a fault of the first computing device 104 itself). In some embodiments, if the first device performance data is not substantially equivalent to the second device performance data the first device performance data was compared against the computing device support apparatus 102 may determine that the first computing device 104 has a device-specific fault. As discussed herein, “comparing” the first device status data to the second device status data may comprise directly comparing data values between devices (e.g. directly comparing battery usage of the first computing device 104 to battery usage of the one or more second computing devices 106) or may comprise applying all or a portion of the first device status data and/or the second device status data to a trained machine learning model trained from historical device status datasets.

As a non-limiting example, the computing device support apparatus 102 may receive first device performance data from the first computing device 104 indicating variations in the position (e.g., a computed error or confidence area of the location measurement, such as a deviation in latitude and/or longitude) of the first computing device 104. The received device performance data may be compared against second device performance data from the one or more second computing devices 106 associated with the position (e.g., latitude and/or longitude) of the one or more second computing devices 106. If the first device performance data and second device performance data are the same or at least substantially equivalent (e.g., the second device performance data indicates variations in the position of at least some of the one or more second computing devices 106 that are equivalent to the variations of the position of the first computing device 104), the computing device support apparatus 102 may determine, for example using the trained machine learning model executed by the machine learning circuitry 210, that the first computing device 104 is affected by a location-specific fault. For example, the first computing device 104 may be affected by a GPS fault, such as a fault associated with a GPS satellite causing position measurement error in that particular location Similarly, the location-specific fault may be geographically-caused, such as being in a mountainous location with poor or inconsistent GPS signal.

If the first device performance data and second device performance data are not substantially equivalent (e.g., the second device performance data does not indicate the same or at least substantially equivalent (e.g., within a predetermined range or other threshold of) variations in the position of at least some of the one or more second computing devices 106), the computing device support apparatus 102 may determine, for example using the trained machine learning model executed by the machine learning circuitry 210, that the first computing device 104 is affected by a device-specific fault, such as a hardware or software problem associated with the GPS sensor or other components on the first computing device 104. In some embodiments, in response to determining that the first computing device 104 is affected by a location-specific fault and/or a device specific fault, the computing device support apparatus 102 under the direction of the support services controller 214 may be configured to cause information regarding the one or more device-specific fault and/or the location-specific fault to be displayed via a graphical user interface 702.

As another non-limiting example, the computing device support apparatus 102 may receive first device performance data from the first computing device 104 indicating that the first computing device 104 has weak cellular signal strength. The received device performance data may be compared against second device performance data from the one or more second computing devices 106 associated with cellular signal strength. If the comparison of the first device performance data and second device performance data indicates that the cellular signal strength of the first computing device 104 is the same or at least substantially equivalent to the cellular signal strength of the one or more second computing devices 106, the computing device support apparatus 102 may determine, for example using the trained machine learning model executed by the machine learning circuitry 210, that the first computing device 104 is affected by a location-specific fault. For example, the first computing device 104 may be affected by a cellular fault, such as a fault associated with a cellular tower or poor signal (e.g., in a rural area or an area with otherwise poor signal).

If the comparison of the first device performance data and second device performance data indicates that the cellular signal strength of the first computing device 104 is not the same or at least substantially equivalent to the cellular signal strength of the one or more second computing devices 106, the computing device support apparatus 102 may determine, for example using the trained machine learning model executed by the machine learning circuitry 210, that the first computing device 104 is affected by a device-specific fault. For example, the first computing device 104 may have a hardware fault associated with the communication interface 310, such as a damaged cellular communications antenna, radio, or other component. In some embodiments, in response to determining that the first computing device 104 is affected by a location-specific fault and/or a device specific fault, the computing device support apparatus 102 under the direction of the support services controller 214 may be configured to cause information regarding the one or more device-specific fault and/or the location-specific fault to be displayed via a graphical user interface 702.

In another non-limiting example, the computing device support apparatus 102 may receive first device performance data from the first computing device 104 indicating that the first computing device 104 is experiencing one or more battery issues, including but not limited to battery capacity issues, battery charge rate issues, battery voltage issues, or battery overheat issues. To detect battery issues, one or more of the following data values may be included in the device performance data, battery identifier(s), battery type, battery voltage data, battery age data, device age data, battery power capacity data, battery state of charge data, battery charge cycle count, battery discharge cycle count, battery charge rate, battery discharge rate, charge voltage data, charging manner data, battery usage data, battery temperature variation data (e.g. during charging, during discharging, etc.), battery overheat alert(s), and/or the like.

The received device performance data may be compared against second device performance data from the one or more second computing devices 106 associated with the one or more battery issues. If the comparison of the first device performance data and second device performance data indicates that the battery performance data associated with the one or more battery issues of the first computing device 104 is the same or at least substantially equivalent to the corresponding battery performance data of the one or more second computing devices 106, the computing device support apparatus 102 may determine, for example using the trained machine learning model executed by the machine learning circuitry 210, that the first computing device 104 is affected by a location-specific fault. For example, the first computing device 104 may be in a location with poor radio signal, which may cause increased battery drain and poorer charge times (e.g., in a rural area or an area with otherwise poor signal).

If the comparison of the first device performance data and second device performance data indicates that the battery performance of the first computing device 104 is not the same or at least substantially equivalent to the battery performance of the one or more second computing devices 106, the computing device support apparatus 102 may determine, for example using the trained machine learning model executed by the machine learning circuitry 210, that the first computing device 104 is affected by a device-specific fault. For example, the first computing device 104 may have a defective or old and declining battery. In some embodiments, in response to determining that the first computing device 104 is affected by a location-specific fault and/or a device specific fault, the computing device support apparatus 102 under the direction of the support services controller 214 may be configured to cause information regarding the one or more device-specific fault and/or the location-specific fault to be displayed via a graphical user interface 702.

In some embodiments, the battery performance prediction server 210 is configured to determine the expected battery performance of a device battery by employing one or more machine learning models (e.g., artificial neural network, convolutional neural network, or other machine learning system). For example, battery performance-related indicators or data points such as battery age, battery capacity, battery charge, charge voltage, and charging matter vary with each device battery and can further by affected by other factors, such as environmental and usage factors—all of which affect how the battery performs and will continue to perform in an associated device. Additionally, sensors in the associated device (e.g., accelerometer, gyroscope, etc.) and algorithms capable of detecting drop-related and/or motion rates directly or indirectly, provide valuable input for machine learning techniques or other similar techniques. Accordingly, in some embodiments, an expected battery performance is determined based upon a machine learning model utilizing such values, variables, parameters and data inputs calculated, received, and/or sent within the battery performance prediction system 200 to identify and/or determine relationships among the various data inputs.

Such machine learning models may be subjected to and/or implement unsupervised training, supervised training, semi-supervised training, reinforcement learning, deep learning, and/or the like in order to analyze battery performance data and in turn, determine and utilize relationships for such battery performance prediction. During training of such a machine learning model (e.g., artificial/convolutional neural network or the like), the model may be iteratively supplied with a plurality of battery performance data such that the model may be configured to, over time, determine patterns amongst the plurality of parameters, values, and data points defined by the battery performance data. Said differently, the machine learning model may be configured to determine a correlation or pattern associated with the values and parameters within the battery performance data so as to determine a more accurate prediction of battery performance.

As another non-limiting example, the computing device support apparatus 102 may receive first device performance data from the first computing device 104 indicating that the first computing device 104 is frequently being disconnected from a Wi-Fi device or suffers from poor Wi-Fi signal. The received device performance data may be compared against second device performance data from the one or more second computing devices 106 associated with the Wi-Fi device. If the first device performance data and second device performance data are the same or at least substantially equivalent (e.g., the second device performance data indicates that at least some of the one or more second computing devices 106 are also frequently being disconnected from the Wi-Fi device), the computing device support apparatus 102 may determine, for example using the trained machine learning model executed by the machine learning circuitry 210, that the first computing device 104 is affected by a location-specific fault. For example, the first computing device 104 may be affected by a Wi-Fi fault, such as a fault with the Wi-Fi device. In such embodiments, the first location 110A may be a home, commercial building, or other location associated with a particular Wi-Fi network. In some embodiments, locations within a single Wi-Fi network may be differentiated as first and second locations (e.g., by comparing the identity of the devices to determine where they are likely located, by triangulating the position of the devices using multiple receivers on the network, by having a user input the location within the Wi-Fi network, or otherwise). If the first device performance data and second device performance data are not the same or at least substantially equivalent (e.g., the second device performance data indicates that few, if any, of the one or more second computing devices 106 are frequently being disconnected from the Wi-Fi device), the computing device support apparatus 102 may determine, for example using the trained machine learning model executed by the machine learning circuitry 210, that the first computing device 104 is affected by a device-specific fault. For example, the first computing device 104 may be affected by a software fault, such as having a malicious application that the Wi-Fi device refuses to connect with, or a hardware fault, such as a faulty Wi-Fi antenna, radio, or other component. In some embodiments, in response to determining that the first computing device 104 is affected by a location-specific fault and/or a device specific fault, the computing device support apparatus 102 under the direction of the support services controller 214 may be configured to cause information regarding the one or more device-specific fault and/or the location-specific fault to be displayed via a graphical user interface 702.

In some embodiments, the computing device support apparatus 102, for example using the trained machine learning model executed with the machine learning circuitry 210, may identify and differentiate between location-specific faults and device-specific faults affecting the first computing device 104 by comparing the first device status data from the first computing device 104 and/or the second device status data from the one or more second computing devices 106 against the third device status data from the one or more third computing devices 108 in the at least one second location 110B. In some embodiments, the at least one second location 110B may be selected as a large distance from the first location 110A. For example, the distance between the first location 110A and the at least one second location 110B may be large enough such that it can be determined that the first computing device 104 and/or the one or more second computing devices 106 are connected to a different satellite(s) than the one or more third computing devices 108 in at least some embodiments for which satellite connection is an input. As another example, the distance between the first location 110A and the at least one second location 110B may be large enough such that it can be determined that the first computing device 104 and/or the one or more second computing devices 106 are connected to a different cellular tower(s) or different cellular network than the one or more third computing devices 108 in at least some embodiments for which such towers or network information are inputs. As another example, the distance between the first location 110A and the at least one second location 110B may be large enough such that it can be determined that the first computing device 104 and/or the one or more second computing devices 106 are connected to a different Wi-Fi network than the one or more third computing devices 108 in at least some embodiments for which Wi-Fi network connection is an input. In such embodiments, the distance may be determined either by comparing the data associated with the location-specific feature (e.g., a satellite ID, cellular tower or network ID, a Wi-Fi network ID) and/or by detecting a geographic distance (e.g., physical distance between actual locations, such as determined by GPS). In some embodiments, multiple sets of data (e.g., cellular network ID and actual distance) may be input to the models. In some embodiments, the computing device support apparatus 102, for example using the trained machine learning model executed by the machine learning circuitry 210, may identify and differentiate between location-specific faults and device-specific faults affecting the first computing device 104 by comparing some or all of the first device performance data and/or some or all of the second device performance data against some or all of the third device performance data. In some embodiments, if the first device performance data and/or the second device performance data is substantially equivalent to the third device performance data, the computing device support apparatus 102 may determine that the first computing device 104 is affected by a device specific fault. In some embodiments, if the first device performance data and/or the second device performance data is determined to not be substantially equivalent to the third device performance data (e.g., the computing device support apparatus 102 may determine that the first computing device 104 is affected by a location specific fault.

As described above, in some embodiments, determining that the first computing device 104 is affected by a location-specific fault and/or a device-specific fault may be done, for example, using the machine learning circuitry 210 to execute one or more trained machine learning models (e.g., via artificial neural network, convolutional neural network, or other machine learning process). In some embodiments, the trained machine learning model may be trained from the plurality of historical device status datasets described above. For example, the trained machine learning model may be trained to recognize patterns suggestive of particular types of location-specific faults and/or a device-specific faults, based on unsupervised learning, supervised learning, semi-supervised learning, reinforcement learning, and/or association rules learning. Various performance-related indicators or data points associated with the various processes discussed herein (e.g., location, radio performance, battery performance, etc.) vary with each device and can further by affected by other factors, such as environmental and usage factors—all of which affect how the device performs and will continue to perform in an associated device. Additionally, sensors in the associated device (e.g., accelerometer, gyroscope, etc.) and algorithms capable of detecting drop-related and/or motion rates directly or indirectly, provide valuable input for machine learning techniques or other similar techniques. Accordingly, in some embodiments, a fault is determined based upon a machine learning model utilizing such values, variables, parameters and data inputs calculated, received, and/or sent within, for example, the computing device support apparatus 102 to identify and/or determine relationships among the various data inputs.

Such machine learning models may be subjected to and/or implement unsupervised training, supervised training, semi-supervised training, reinforcement learning, deep learning, and/or the like in order to analyze device status data and, in some embodiments, device performance data and in turn, determine and utilize relationships for such device data. During training of such a machine learning model (e.g., artificial/convolutional neural network or the like), the model may be iteratively supplied with a plurality of device performance data such that the model may be configured to, over time, determine patterns amongst the plurality of parameters, values, and data points defined by the device performance data. Said differently, the machine learning model may be configured to determine a correlation or pattern associated with the values and parameters within the device performance data so as to determine a more accurate prediction of device performance. For example, in some embodiments, the computing device support apparatus 102 may employ such a model to predict an expected performance of the first computing device based on the data provided by the second computing devices and compare the predicted performance with the actual performance of the first computing device based on the data received from the first computing device. Similarly, in some embodiments, the computing device support apparatus 102 may employ such a model to predict an expected performance of the first computing device based on the data provided by the third computing devices in one or more second locations and compare the predicted performance with the actual performance of the first computing device and/or the predicted values associated with a model run for the second computing devices.

For example, in some embodiments, based on the training from the historical device status datasets the trained machine learning model executed by the machine learning circuitry 210 may be able to determine that the first device performance data and the second device performance data are substantially equivalent, such that the first computing device 104 is affected by a location-specific fault. In some embodiments, substantially equivalent may vary based on the particular device performance data that is being compared. As another example, based on the training from the historical device status datasets the trained machine learning model executed by the machine learning circuitry 210 may be able to determine how many of the one or more second computing devices 106 must have substantially equivalent device performance data before a fault is identified as a location-specific fault. For example, the trained machine learning model executed by the machine learning circuitry 210 may be able to differentiate between situations in which the first computing device 104 and at least some of the one or more second computing devices 106 are affected by a similar device-specific fault and the first computing device 104 and the one or more second computing devices 106 are affected by a location-specific fault.

### Identification of the Extent of a Location-Specific Fault

In some embodiments, the computing device support apparatus 102 may “zoom out” or “zoom in” on the available data to determine how widespread a location-specific fault is. For example, the second device(s) status data may be subdivided into sub-parts to determine if the sub-parts are equally experiencing the location-specific fault or if the location-specific fault affects one sub-part more than the others. In another example, the second device(s) status data may be expanded (e.g., by selecting device data taken from just outside the first location 110A, by selecting data from the third device status data, and/or the like) to determine whether devices beyond the first location 110A are also experiencing the problem. The data may be subdivided and/or expanded using any of the distinguishing data discussed herein (e.g., absolute location, metadata, etc.).

In some embodiments, if the computing device support apparatus 102 determines that the first computing device 104 is affected by a location-specific fault, the computing device support apparatus 102 may be configured, for example using the trained machine learning model executed by the machine learning circuitry 210, to determine the extent of the location-specific fault (e.g., how widespread the performance issue leading to the detection of the fault is). For example, the computing device support apparatus 102 may be able to determine whether a particular hierarchical level of a local infrastructure is at fault based on absolute position data (e.g., GPS data) and/or based on metadata associated with the location (e.g., connected satellites, Wi-Fi networks, nearby landmarks, etc.). For example, in some embodiments, the computing device support apparatus 102 may initially compare the first device status data and/or the second device status data with third device status data from the one or more third computing devices 108 that are in the one or more second locations to determine if the one or more third computing devices 108 are also affected by the location-specific fault. This comparison may be made with real time data and/or historical data as discussed herein. In some embodiments, in response to determining that the one or more third computing devices 108 are also affected by the location-specific fault, the computing device support apparatus 102 may compare the first device status data, the second device status data, and/or the third device status data with other device status data associated with computing devices in other locations until the extent of the location-specific fault is determined (e.g. the computing device support apparatus 102 determines that computing devices in another location are not suffering from the location-specific fault).

As a non-limiting example, if the computing device support apparatus 102 determines, for example using the trained machine learning model executed by the machine learning circuitry 210, that the first computing device 104 is affected by a location-specific fault associated with a GPS fault, the computing device support apparatus 102 may determine how widespread the GPS fault is. In some embodiments, such as illustrated in FIG. 4, the first device performance data and/or the second device performance data may be compared against third device performance data associated with the one or more third computing devices 108. If the first device performance data and/or the second device performance data are not the same or at least substantially equivalent to the third device performance data in the relevant metrics, the computing device support apparatus 102, for example using the trained machine learning model executed by the machine learning circuitry 210, may determine that the location-specific fault is restricted to the computing devices in the first location 110A. For example, such a determination could indicate a location-specific fault associated with a first satellite 402A. If the first device performance data and/or the second device performance data are the same or are at least substantially equivalent to the third device performance data, the computing device support apparatus 102 may compare the first device performance data, the second device performance data, and/or the third device performance data to other device performance data associated with computing devices in other locations. If the first device performance data, the second device performance data, and/or the third device performance are not the same or at least substantially equivalent to the other device performance data in the relevant metrics, the computing device support apparatus 102, for example using the trained machine learning model executed by the machine learning circuitry 210, may determine that the location-specific fault extends to include both the first location 110A and the at least one second location 110B. For example, such a determination could indicate the location-specific fault is being caused by a broader GPS network that includes both the first satellite 402A and the second satellite 402B.

As another non-limiting example, if the computing device support apparatus 102 determines, for example using the trained machine learning model executed by the machine learning circuitry 210, that the first computing device 104 is affected by a location-specific fault associated with a cellular fault, the computing device support apparatus 102 may determine how widespread the cellular fault is. In some embodiments, such as illustrated in FIG. 5, the first device performance data and/or the second device performance data may be compared against third device performance data associated with the one or more third computing devices 108. If the first device performance data and/or the second device performance data are not substantially equivalent to the third device performance data, the computing device support apparatus 102, for example using the trained machine learning model executed by the machine learning circuitry 210, may determine that the location-specific fault is restricted to computing devices in the first location 110A. For example, such a determination could indicate that the location-specific fault is being caused by a fault associated with a first cellular tower 512A. If the first device performance data and/or the second device performance data are the same or are at least substantially equivalent to the third device performance data, the computing device support apparatus 102 may compare the first device performance data, the second device performance data, and/or the third device performance data to other device performance data associated with computing devices in other locations. If the first device performance data, the second device performance data, and/or the third device performance are not the same or at least substantially equivalent to the other device performance data in the relevant metrics, the computing device support apparatus 102, for example using the trained machine learning model executed by the machine learning circuitry 210, may determine that the location-specific fault extends to include both the first location 110A and the at least one second location 110B. For example, such a determination could indicate that the location-specific fault is being caused by a fault associated with a cellular network such as cellular network A 514A. Alternatively, in some embodiments, the computing device support apparatus 102 may determine that there is no cellular fault with the cellular network/tower if devices connected to the same tower, but in slightly different locations, are not experiencing the same fault.

As another non-limiting example, if the computing device support apparatus 102 determines, for example using the trained machine learning model executed by the machine learning circuitry 210, that the first computing device 104 is affected by a location-specific fault associated with a Wi-Fi fault, the computing device support apparatus 102 may determine how widespread the Wi-Fi fault is. In some embodiments, such as illustrated in FIG. 6, the first device performance data and/or the second device performance data may be compared against third device performance data associated with the one or more third computing devices 108. If the first device performance data and/or the second device performance data are not the same or at least substantially equivalent to the third device performance data, the computing device support apparatus 102, for example using the trained machine learning model executed by the machine learning circuitry 210, may determine that the location-specific fault is restricted to computing devices in the first location 110A. For example, such a determination could indicate that the location-specific fault is being caused by a fault associated with a particular Wi-Fi device, such as first Wi-Fi device 604A. If the first device performance data and/or the second device performance data are the same or are at least substantially equivalent to the third device performance data, the computing device support apparatus 102 may compare the first device performance data, the second device performance data, and/or the third device performance data to other device performance data associated with computing devices in other locations. If the first device performance data, the second device performance data, and/or the third device performance are not the same or at least substantially equivalent to the other device performance data in the relevant metrics, the computing device support apparatus 102, for example using the trained machine learning model executed by the trained machine learning model executed by the machine learning circuitry 210, may determine that the location-specific fault extends to include both the first location 110A and the at least one second location 110B. For example, such a determination could indicate that the location-specific fault is being caused by a fault associated with a broader Wi-Fi network, such as a Wi-Fi network for an entire house or office building that includes both first Wi-Fi device 604A and second Wi-Fi device 604B. Alternatively, in some embodiments, the computing device support apparatus 102 may determine that there is no fault with the Wi-Fi device itself if devices connected to the same Wi-Fi device, but in slightly different locations, are not experiencing the same fault.

In some embodiments, the location-based fault detection algorithm may be run a plurality of times using different locations to identify a best fit for the locations associated with the problem, which may also include in some embodiments using different and/or multiple location detection means for defining the location.

In some embodiments, the computing device support apparatus 102 may be configured, for example using the trained machine learning model executed by the machine learning circuitry 210, to determine the extent of the location-specific fault by comparing the first device status data with device status data associated with a plurality of devices in a plurality of locations. For example, the first device performance data may be compared against the device performance data of the plurality of devices and identify devices of the plurality of devices that have the same or substantially equivalent device performance data. Then, for example, the computing device support apparatus 102, for example using the trained machine learning model executed by the machine learning circuitry 210, may compare the first location-indicative data against the location-indicative data of the identified devices to determine the extent of the location-specific fault (e.g. how many devices are affected and/or how widespread the performance issue leading to the detection of the fault is) by determining if the first location-indicative data and the location-indicative data of the identified devices is the same or substantially similar (e.g. the first location-indicative data and the location indicative data of the identified devices indicates that the first computing device 104 and the identified devices are connected to the same cellular tower). For example, in some embodiments, In a similar manner, the extent of any location-specific fault may be determined by changing the specificity of the data set to increasingly or decreasingly specific or to different subsets of data to identify the root commonality causing the problem (e.g., all devices within a certain zip code, a certain radius of a known landmark, etc. for absolute position or all devices connected to a certain Wi-Fi or cellular network, etc. for metadata related faults). In a similar manner, the extent of any device-specific fault may be determined, for example, by changing the specificity of the data set to increasingly or decreasingly specific or to different subsets of data to identify the root commonality causing the problem (e.g., testing all devices of a same processor type, device make and model, battery size, etc.).

### Graphical User Interface

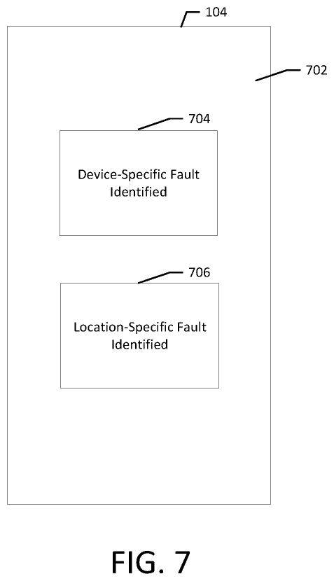

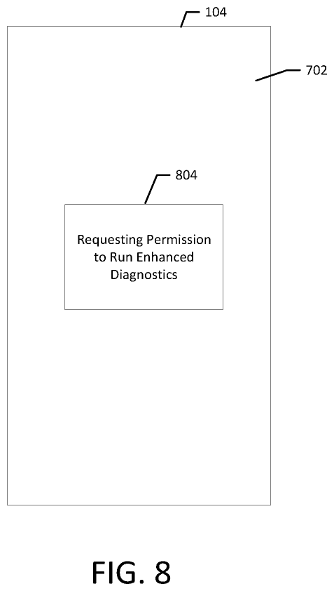

Referring now to FIGS. 7 and 8, in some embodiments, the computing device support apparatus 102 under the direction of the support services controller 214 may be configured to cause information regarding the one or more device-specific fault and/or the location-specific fault to be displayed via a graphical user interface 702 on the first computing device 104. In some embodiments, the information regarding the one or more device-specific fault and/or the location-specific fault may include text, which may be included in a box displayed on the graphical user interface 702. For example, text in a first box 704 may indicate that a device-specific fault was identified. As another example, text in a second box 706 may indicate that a location-specific fault was identified. In some embodiments, the information regarding the one or more device-specific fault and/or the location-specific fault may be accompanied by additional graphical displays indicating if a fault was identified (e.g., coloring, check marks, an “x”) and if so how many faults were detected and/or the extent of the location-based fault. In some embodiments, the information regarding the one or more device-specific fault and/or the location-specific fault may be accompanied by additional alerts, such as audible notifications, vibrations of the first computing device 104, and/or the like. Additionally or alternatively, a substantially similar interface may be displayed on a second graphical user interface associated with a carrier, provider, or other third-party computing system that works with, supports, or provides services to the first computing device 104.

In some embodiments, as illustrated in FIG. 8, the computing device support apparatus 102 under the direction of the support services controller 214 may be configured to cause text in a third box 804 to appear on the graphical user interface 702 of the first computing device 104 requesting permission to run enhanced diagnostics. In some embodiments, the request for permission to run enhanced diagnostics may be presented on the graphical user interface 702 before the computing device support apparatus 102 collects first device status data from the first computing device 104. In other embodiments, the request for permission to run enhanced diagnostics may be presented on the graphical user interface 702 after the computing device support apparatus 102 has collected first device status data from the first computing device 104, but before one or more device-specific fault and/or location-specific fault are identified. In still other embodiments, the request for permission to run enhanced diagnostics may be presented on the graphical user interface 702 after a device-specific fault is identified. In some embodiments, the graphical user interface 702 may be configured such that the third box 804 may be selected to indicate the permission to run enhanced diagnostics. For example, in an instance in which permission to run enhanced diagnostics is received after a device-specific fault is detected, the enhanced diagnostics may be used to determine if the device-specific fault is a hardware fault or a software fault. Additionally or alternatively, a substantially similar interface may be displayed on a second graphical user interface associated with a carrier, provider, or other third-party computing system that works with, supports, or provides services to the first computing device 104, including a personal computer or other device associated with the user.

Example Processes Identifying Device-Specific Faults and Location-Specific Faults

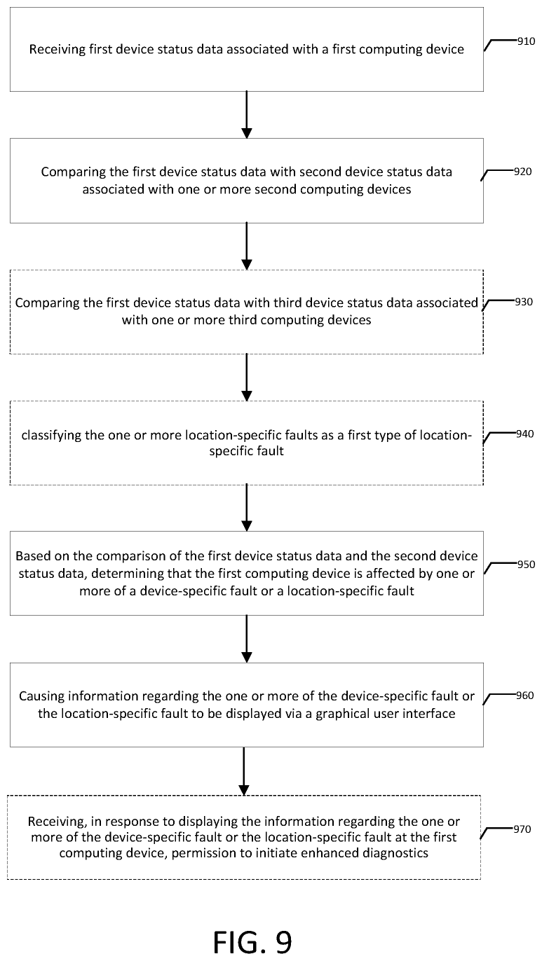

Referring now to FIG. 9, FIG. 9 illustrates a flowchart according to an example process 900 for providing computing device support services, including for identifying and differentiating between location-specific faults and device-specific faults according to some example embodiments. In this regard, FIG. 9 illustrates operations that may be performed at and/or by the computing device support apparatus 102 and/or the first computing device 104. The operations illustrated in and described with respect to FIG. 9 may, for example, be performed by, with the assistance of, and/or under the control of one or more of the processing circuitry 202, processor 208, memory 206, the trained machine learning model executed by machine learning circuitry 210, communication interface 212, support services controller 214, processing circuitry 302, processor 306, memory 304, user interface 308, communication interface 310, and/or computer application controller 312.

As shown at block 910, the process 900 begins with receiving first device status data associated with a first computing device. The first device status data may include first location-indicative data indicative of a location of the first computing device and first device performance data indicative of the performance of the first computing device. In some example implementations, at least some of the first device status data may be provided in real time. In some example implementations, the first device status data may also include an indication of at least one fault associated with the first computing device (e.g., a fault identified by the device or another computing system prior to location-based fault analysis or data that, once analyzed by the computing device support apparatus, is indicative of a fault). In some example implementations, the first location-indicative data may be based on one or more of global positioning system data, cellular data, Wi-Fi data, manually-entered location information, or any other data indicative of a location of the device. In some example implementations, the first computing device is in the first location when within a recognized geographical zone and the size of the recognized geographical zone may be determined based at least in part on the one or more types of location-indicative data used to determine the first location-indicative data.

As shown at block 920, the process 900 continues with the comparison of the first device status data with second device status data associated with one or more second computing devices. The second device status data may include second location-indicative data indicative of the location(s) of the one or more second computing devices and second device performance data indicative of the performance of the one or more second computing devices. In some example implementations, the second location-indicative data may be based on one or more of global positioning system data, cellular data, or Wi-Fi data. In some example implementations, the one or more second computing device are in the first location when within a recognized geographical zone and the size of the recognized geographical zone may be determined based at least in part on the one or more types of location-indicative data used to determine the second location-indicative data. In some example implementations, the comparison of the first device status data and the second device status data is done by the trained machine learning model executed by machine learning circuitry. In some example implementations, the trained machine learning model was trained using historical device status datasets that include historical location-indicative datasets from a plurality of computing devices experiencing a location-specific fault.

As shown in block 930, the process 900 may optionally include comparing the first device status data with third device status data associated with one or more third computing devices. In some example implementations, the third device status data may include third location-indicative data indicative of at least one second location.

As shown in block 940, in an instance in which the first computing device is affected by the location-specific fault, the process 900 may optionally classify the location-specific fault as a first type of location-specific fault. In some example implementations the first type of the location-specific fault may be one of a global position system fault, a Wi-Fi fault, or a cellular fault (e.g. faults associated with a cellular tower or poor signal in a rural area). In some example implementations, the first type of the location-specific fault may be one of a global position system network fault, a Wi-Fi network fault, or a cellular network fault.

As shown in block 950, based on the comparison of the first device status data and the second device status data in block 920, the process 900 includes determining that the first computing device is affected by one or more of a device-specific fault or a location-specific fault. In some example implementations, at block 950 the process 900 may determine that the first computing device is affected by the location-specific fault when the first device performance data is the same or at least substantially equivalent to the second device performance data. In some example implementations, at block 950 the process 900 may determine that the first computing device is affected by the location-specific fault when the first device performance data is the same or at least substantially equivalent to the second device performance data and different from third device performance data associated with one or more third computing devices not located at the location of the first computing device. In some example implementations, at block 950 the process 900 may determine that the first computing device is affected by the device-specific fault when the first device performance data is different than the second device performance data. In some example implementations, at block 950 the process 900 may determine that the device-specific fault may be a software fault or a hardware fault.

As shown in block 960, the process 900 continues by causing information regarding the one or more of the device-specific faults or the location-specific fault to be displayed via a graphical user interface. As shown in block 970, in some example implementations, the process 900 may optionally receive, in response to displaying the information regarding the one or more of the device-specific fault or the location-specific fault at the first computing device, permission to initiate enhanced diagnostics.

### CONCLUSION

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Although specific terms are employed herein, they are used in a descriptive sense and not for purposes of limitation.

What is claimed is:

1. A method comprising:
receiving first device status data associated with a first computing device, wherein the first device status data comprises first location-indicative data indicative of a location;
comparing the first device status data with second device status data associated with one or more second computing devices, wherein the second device status data comprises second location-indicative data indicative of the location;
based on the comparison of the first device status data and the second device status data, determining that the first computing device is affected by one or more of a device-specific fault or a location-specific fault; and
causing information regarding the one or more of the device-specific fault or the location-specific fault to be displayed via a graphical user interface.

2. The method of claim 1, wherein the comparison of the first device status data and the second device status data is done by a trained machine learning model executed by machine learning circuitry.

3. The method of claim 2, wherein the trained machine learning model was trained using historical device status datasets comprising historical location-indicative datasets from a plurality of computing devices experiencing a location-specific fault.

4. The method of claim 1, wherein the first location-indicative data and the second location-indicative data may be based on one or more of global positioning system data, cellular data, or Wi-Fi data.

5. The method of claim 2, wherein in an instance in which the first computing device is affected by the location-specific fault, the method further comprises:
classifying the location-specific fault as a first type of location-specific fault using the trained machine learning model.

6. The method of claim 5, wherein the first type of the location-specific fault may be one of a global positioning system fault, a Wi-Fi fault, or a cellular fault.

7. The method of claim 5, wherein the first type of the location-specific fault may be one of a global positioning system network fault, a Wi-Fi network fault, or a cellular network fault.

8. The method of claim 4, wherein the first location-indicative data being indicative of the location means that the first computing device is within a recognized geographical zone and wherein the second location-indicative data being indicative of the location means that the second computing devices is within the recognized geographical zone.

9. The method of claim 8, wherein a size of the recognized geographical zone is determined based at least in part on the one or more types of location-indicative data used to determine the first location-indicative data and the second location-indicative data.

10. The method of claim 1, wherein the first location-indicative data is provided in real-time.

11. The method of claim 1, wherein the first device status data further comprises first device performance data and the second device status data further comprises second device performance data.

12. The method of claim 1, wherein the first device status data further comprises an indication of at least one fault.

13. The method of claim 11, further comprising:
comparing the first device status data with third device status data associated with one or more third computing devices, wherein the third device status data comprises third device performance data and third location-indicative data indicative of at least one second location, wherein the at least one second location is different than the location, wherein the first computing device is affected by the device-specific fault in an instance in which the first device performance data is substantially equivalent to the third device performance data, and wherein the first computing device is affected by the location-specific fault in an instance in which the first device performance data is different than the third device performance data.

14. The method of claim 1, wherein the one or more device-specific fault may be a software fault or a hardware fault.

15. The method of claim 1, further comprising:
receiving, in response to displaying the information regarding the one or more of the device-specific fault or the location-specific fault at the first computing device, permission to initiate enhanced diagnostics.

16. The method of claim 1, wherein the first computing device and the one or more second computing devices have a device profile, the device profile comprising one or more characteristics.

17. The method of claim 11, wherein the first computing device is affected by the location-specific fault when the first device performance data is substantially equivalent to the second device performance data.

18. The method of claim 11, wherein the first computing device is affected by the device-specific fault when the first device performance data is different than the second device performance data.

19. A system comprising at least one processor and at least one memory including computer program code, the at least one memory and the computer program code configured to, with the processor, cause the system to at least:
receive first device status data associated with a first computing device, wherein the first device status data comprises first location-indicative data indicative of a location;
compare the first device status data with second device status data associated with one or more second computing devices, wherein the second device status data comprises second location-indicative data indicative of the location;
based on the comparison of the first device status data and the second device status data, determine that the first computing device is affected by one or more of a device-specific fault or a location-specific fault; and
cause information regarding the one or more of the device-specific fault or the location-specific fault to be displayed via a graphical user interface.

20. The system of claim 19, wherein the comparison of the first device status data and the second device status data is done by a trained machine learning model executed by machine learning circuitry and wherein the trained machine learning model was trained using historical device status datasets comprising historical location-indicative datasets from a plurality of computing devices experiencing a location-specific fault.

21. The system of claim 19, wherein the first location-indicative data and the second location-indicative data may be based on one or more of global positioning system data, cellular data, or Wi-Fi data.

22. The system of claim 19, wherein in an instance in which the first computing device is affected by the location-specific fault, the at least one memory and the computer program code are further configured to, with the processor, cause the system to:
classify the location-specific fault as a first type of location-specific fault using a trained machine learning model executed by machine learning circuitry.

23. The system of claim 22, wherein the first type of location-specific fault may be one of a global positioning system fault, a Wi-Fi fault, or a cellular fault.

24. The system of claim 21, wherein the first location-indicative data being indicative of the location means that the first computing device is within a recognized geographical zone, wherein the second location-indicative data being indicative of the location means that the second computing devices is within the recognized geographical zone, and wherein a size of the recognized geographical zone is determined based at least in part on the one or more types of location-indicative data used to determine the first location-indicative data and the second location-indicative data.

25. The system of claim 19, wherein the first location-indicative data is provided in real-time.

26. The system of claim 19, wherein the first device status data further comprises first device performance data and the second device status data further comprises second device performance data.

27. The system of claim 26, wherein the at least one memory and the computer program code are further configured to, with the processor, cause the system to:
compare the first device status data with third device status data associated with one or more third computing devices, wherein the third device status data comprises third device performance data and third location-indicative data indicative of at least one second location, wherein the at least one second location is different than the location, wherein the first computing device is affected by the device-specific fault in an instance in which the first device performance data is substantially equivalent to the third device performance data, and wherein the first computing device is affected by the location-specific fault in an instance in which the first device performance data is different than the third device performance data.

28. The system of claim 19, wherein the first device status data further comprises an indication of at least one fault.

29. The system of claim 19, wherein the at least one memory and the computer program code are further configured to, with the processor, cause the system to:
receive, in response to displaying the information regarding the one or more of the device-specific fault or the location-specific fault at the first computing device, permission to initiate enhanced diagnostics.

30. A computer program product comprising a non-transitory computer-readable storage medium having program code portions stored therein, the program code portions being configured to, upon execution, direct a system to at least:
receive first device status data associated with a first computing device, wherein the first device status data comprises first location-indicative data indicative of a location;
compare the first device status data with second device status data associated with one or more second computing devices, wherein the second device status data comprises second location-indicative data indicative of the location;
based on the comparison of the first device status data and the second device status data, determine that the first computing device is affected by one or more of a device-specific fault or a location-specific fault; and
cause information regarding the device-specific fault or the location-specific fault to be displayed via a graphical user interface.
